(19) United States
(12) Patent Application Publication
(10) Pub. No.: US 2013/0150500 A1
(43) Pub. Date: Jun. 13, 2013

(54) PROCESS FOR DISPERSING CELLULOSE ESTERS INTO ELASTOMERIC COMPOSITIONS

(71) Applicant: Eatman Chemical Company, Kingsport, TN (US)

(72) Inventors: Marcus David Shelby, Fall Branch, TN (US); Michael Eugene Donelson, Kingsport, TN (US); Jeff Scott Howell, Jonesborough, TN (US); Soumendra Kumar Basu, Johnson City, TN (US); Bradley James Helmer, Kingsport, TN (US); Matthew Davie Wood, Gray, TN (US); Chris Stanley Dagenhart, Johnson City, TN (US)

(73) Assignee: Eatman Chemical Company, Kingsport, TN (US)

(21) Appl. No.: 13/690,890

(22) Filed: Nov. 30, 2012

Related U.S. Application Data
(60) Provisional application No. 61/567,953, filed on Dec. 7, 2011.
(60) Provisional application No. 61/567,950, filed on Dec. 7, 2011.
(60) Provisional application No. 61/567,948, filed on Dec. 7, 2011.
(60) Provisional application No. 61/657,951, filed on Jun. 11, 2012.

(51) Int. Cl. C08K 5/1545

(52) U.S. Cl. CPC C08K 5/1545
USPC 524/41

(57) ABSTRACT

An elastomeric composition is provided comprising at least one non-fibril cellulose ester, at least one carrier elastomer, and at least one primary elastomer, wherein the elastomeric composition exhibits a dynamic mechanical analysis (DMA) strain sweep modulus as measured at 5% strain and 30° C. of at least 1,450,000 Pa and a molded groove tear as measured according to ASTM D624 of at least 120 lbf/in.

### RELATED APPLICATIONS

This application claims priority to U.S. Provisional Application Ser. Nos. 61/567,948, 61/567,950, 61/567,951, and 61/567,953 filed on Dec. 7, 2011, the disclosures of which are incorporated herein by reference to the extent they do not contradict the statements herein.

### FIELD OF THE INVENTION

The present invention relates generally to elastomeric compositions comprising a cellulose ester and to processes for making such elastomeric compositions.

### BACKGROUND OF THE INVENTION

Reinforcing fillers are regularly incorporated into elastomeric compositions in order to improve the mechanical properties and abrasion resistance of the elastomeric compositions. Reinforcing fillers can encompass a vast array of materials and new types of reinforcing fillers are always being studied and developed. For example, the use of cellulose esters as reinforcing fillers in elastomeric compositions has recently been examined.

It has been observed that certain cellulose esters can be directly melt blended into elastomeric compositions and function as a reinforcing filler therein. These melt blending processes generally blend the cellulose esters directly with elastomers at processing temperatures of 160° C. or below. These lower processing temperatures are required in order to minimize any adverse degradation and/or premature crosslinking of the elastomers. However, most cellulose esters have a high glass transition temperature (“Tg”) and are unable to effectively melt and disperse throughout the elastomer at these temperatures. Thus, due to the restrictive processing temperatures in these melt blending processes, the full potential of high Tg cellulose esters is not achieved. As a result, these melt blending processes are only able to effectively utilize cellulose esters having lower glass transition temperatures.

Unfortunately, the use of low Tg cellulose esters can lead to a number of undesirable attributes in the elastomeric composition. For instance, the lower Tg of the cellulose ester adversely affects the rolling resistance of the elastomeric composition, thereby making it less desirable for certain end uses, such as in tires. In addition, the use of low Tg cellulose esters results in a “softer” filler that does not provide the same level of reinforcement and wear resistance as other conventional reinforcing fillers.

Accordingly, there is a need for a process to effectively incorporate and disperse cellulose esters having higher glass transition temperatures into elastomeric compositions.

### BRIEF SUMMARY OF THE INVENTION

In one embodiment of the present invention, a cellulose ester concentrate is provided. The cellulose ester concentrate comprises at least one non-nitrile carrier elastomer and at least one non-fibril cellulose ester. The Tg of the cellulose ester is greater than the Tg of the carrier elastomer. The cellulose ester concentrate comprises at least 15 weight percent of the cellulose ester.

In another embodiment of the present invention, a process to produce a cellulose ester concentrate is provided. The process comprises mixing at least one cellulose ester with one or more carrier elastomers to produce the cellulose ester concentrate. At least a portion of the mixing occurs at a temperature that exceeds the Tg of the cellulose ester. Additionally, at least a portion of the mixing operates at a shear rate of at least 50 s⁻¹.

In yet another embodiment of the present invention, an elastomeric composition is provided. The elastomeric composition comprises at least one non-fibril cellulose ester, at least one carrier elastomer, and at least one primary elastomer. The elastomeric composition exhibits a dynamic mechanical analysis (DMA) strain sweep modulus as measured at 5% strain and 30° C. of at least 1,450,000 Pa and a molded groove tear as measured according to ASTM D624 of at least 120 lbf/in.

In still yet another embodiment of the present invention, a process to produce an elastomeric composition is provided. The process comprises: (a) mixing at least one cellulose ester with one or more carrier elastomers to form a cellulose ester concentrate; and (b) blending the cellulose ester concentrate with at least one primary elastomer to produce an elastomeric composition. At least a portion of the mixing of step (a) occurs at a temperature that is at least 10° C. greater than the temperature of the blending of step (b).

Other inventions concerning the use of cellulose esters in elastomers have been filed in original applications by Eastman Chemical Company on Nov. 30, 2012 entitled “Cellulose Esters in Highly Filled Elastomeric Systems”, “Cellulose Esters in Pneumatic Tires”, and “Cellulose Ester Elastomer Compositions; the disclosures of which are hereby incorporated by reference to the extent that they do not contradict the statements herein.

### DETAILED DESCRIPTION

This invention relates generally to the dispersion of cellulose esters into elastomeric compositions in order to improve the mechanical and physical properties of the elastomeric composition. It has been observed that cellulose esters can provide a dual functionality when utilized in elastomeric compositions and their production. For instance, cellulose esters can act as a processing aid since they can melt and flow at elastomer processing temperatures thereby breaking down into smaller particles and reducing the viscosity of the composition during processing. After being dispersed throughout the elastomeric composition, the cellulose esters can re-solidify upon cooling and can act as a reinforcing filler that strengthens the composition.

In certain embodiments of this invention, a process to produce an elastomeric composition is provided that utilizes a cellulose ester concentrate. The use of this cellulose ester concentrate enables the effective dispersion of higher Tg cellulose esters into the elastomeric compositions. These cellulose ester concentrates can be produced by mixing a cellulose ester with at least one carrier elastomer at temperatures that can exceed those of conventional elastomer processing (e.g., 160° C.). By forming a cellulose ester concentrate at these higher temperatures, high Tg cellulose esters can be more effectively softened and/or dispersed in the cellulose ester concentrate, thereby decreasing the particle size of the cellulose esters. Consequently, these smaller particles of cellulose esters in the cellulose ester concentrate can be more effectively dispersed throughout the elastomeric composition when the cellulose ester concentrate is blended with a primary elastomer.

In certain embodiments of this invention, an elastomeric composition is provided that comprises at least one cellulose ester, at least one primary elastomer, at least one carrier elastomer, optionally, one or more fillers, and, optionally, one or more additives. In other embodiments of this invention, a cellulose ester concentrate is provided that comprises at least one cellulose ester, at least one carrier elastomer, optionally, one or more fillers, and, optionally, one or more additives.

### (A) Cellulose Esters

The elastomeric composition of the present invention can comprise at least about 1, 2, 3, 4, 5, or 10 parts per hundred rubber (“phr”) of at least one cellulose ester, based on the total weight of the elastomers. Additionally or alternatively, the elastomeric composition of the present invention can comprise not more than about 75, 50, 40, 30, or 20 phr of at least one cellulose ester, based on the total weight of the elastomers. The term “phr,” as used herein, refers to parts of a respective material per 100 parts by weight of rubber or elastomer.

The cellulose ester utilized in this invention can be any that is known in the art. The cellulose esters useful in the present invention can be prepared using techniques known in the art or can be commercially obtained, e.g., from Eastman Chemical Company, Kingsport, Tenn., U.S.A.

The cellulose esters of the present invention generally comprise repeating units of the structure:

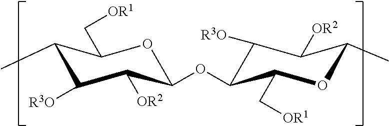

wherein R¹, R², and R³ may be selected independently from the group consisting of hydrogen or a straight chain alkanoyl having from 2 to 10 carbon atoms. For cellulose esters, the substitution level is usually expressed in terms of degree of substitution (“DS”), which is the average number of substitutents per anhydroglucose unit (“AGU”). Generally, conventional cellulose contains three hydroxyl groups per AGU that can be substituted; therefore, the DS can have a value between zero and three. Alternatively, lower molecular weight cellulose mixed esters can have a total degree of substitution ranging from about 3.08 to about 3.5. Generally, cellulose is a large polysaccharide with a degree of polymerization from 700 to 2,000 and a maximum DS of 3.0. However, as the degree of polymerization is lowered, as in low molecular weight cellulose mixed esters, the end groups of the polysaccharide backbone become relatively more significant, thereby resulting in a DS ranging from about 3.08 to about 3.5.

Because DS is a statistical mean value, a value of 1 does not assure that every AGU has a single substituent. In some cases, there can be unsubstituted AGUs, some with two substitutents, and some with three substitutents. The “total DS” is defined as the average number of substitutents per AGU. In one embodiment of the invention, the cellulose esters can have a total DS per AGU (DS/AGU) of at least about 0.5, 0.8, 1.2, 1.5, or 1.7. Additionally or alternatively, the cellulose esters can have a total DS/AGU of not more than about 3.0, 2.9, 2.8, or 2.7. The DS/AGU can also refer to a particular substituent, such as, for example, hydroxyl, acetyl, butyryl, or propionyl. For instance, a cellulose acetate can have a total DS/AGU for acetyl of about 2.0 to about 2.5, while a cellulose acetate propionate (“CAP”) and cellulose acetate butyrate (“CAB”) can have a total DS/AGU of about 1.7 to about 2.8.

The cellulose ester can be a cellulose triester or a secondary cellulose ester. Examples of cellulose triesters include, but are not limited to, cellulose triacetate, cellulose tripropionate, or cellulose tributyrate. Examples of secondary cellulose esters include cellulose acetate, cellulose acetate propionate, and cellulose acetate butyrate. These cellulose esters are described in U.S. Pat. Nos. 1,698,049; 1,683,347; 1,880,808; 1,880,560; 1,984,147, 2,129,052; and 3,617,201, which are incorporated herein by reference in their entirety to the extent they do not contradict the statements herein.

In one embodiment of the invention, the cellulose ester is selected from the group consisting of cellulose acetate, cellulose acetate propionate, cellulose acetate butyrate, cellulose triacetate, cellulose tripropionate, cellulose tributyrate, and mixtures thereof.

The degree of polymerization (“DP”) as used herein refers to the number of AGUs per molecule of cellulose ester. In one embodiment of the invention, the cellulose esters can have a DP of at least about 2, 10, 50, or 100. Additionally or alternatively, the cellulose esters can have a DP of not more than about 10,000, 8,000, 6,000, or 5,000.

In certain embodiments, the cellulose esters can have an inherent viscosity (“IV”) of at least about 0.2, 0.4, 0.6, 0.8, or 1.0 deciliters/gram as measured at a temperature of 25° C. for a 0.25 gram sample in 100 ml of a 60/40 by weight solution of phenol/tetrachloroethane. Additionally or alternatively, the cellulose esters can have an IV of not more than about 3.0, 2.5, 2.0, or 1.5 deciliters/gram as measured at a temperature of 25° C. for a 0.25 gram sample in 100 ml of a 60/40 by weight solution of phenol/tetrachloroethane.

In certain embodiments, the cellulose esters can have a falling ball viscosity of at least about 0.005, 0.01, 0.05, 0.1, 0.5, 1, or 5 pascals-second (“Pa·s”). Additionally or alternatively, the cellulose esters can have a falling ball viscosity of not more than about 50, 45, 40, 35, 30, 25, 20, or 10 Pa·s.

In certain embodiments, the cellulose esters can have a hydroxyl content of at least about 1.2, 1.4, 1.6, 1.8, or 2.0 weight percent.

In certain embodiments, the cellulose esters useful in the present invention can have a weight average molecular weight (M_{w}) of at least about 5,000, 10,000, 15,000, or 20,000 as measured by gel permeation chromatography (“GPC”). Additionally or alternatively, the cellulose esters useful in the present invention can have a weight average molecular weight (M_{w}) of not more than about 400,000, 300,000, 250,000, 100,000, or 80,000 as measured by GPC. In another embodiment, the cellulose esters useful in the present invention can have a number average molecular weight (Mₙ) of at least about 2,000, 4,000, 6,000, or 8,000 as measured by GPC. Additionally or alternatively, the cellulose esters useful in the present invention can have a number average molecular weight (Mₙ) of not more than about 100,000, 80,000, 60,000, or 40,000 as measured by GPC.

In certain embodiments, the cellulose esters can have a glass transition temperature (“Tg”) of at least about 30° C., 40° C., 50° C., 55° C., 60° C., 65° C., 70° C., 75° C., or 80° C. Additionally or alternatively, the cellulose esters can have a Tg of not more than about 200° C., 190° C., 180° C., 170° C., 160° C., 150° C., 140° C., or 130° C.

In one embodiment of the present invention, the cellulose esters utilized in the elastomeric compositions have not previously been subjected to fibrillation or any other fiber-producing process. In such an embodiment, the cellulose esters are not in the form of fibrils and can be referred to as “non-fibril.”

The cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and from sources such as, for example, cotton linters, softwood pulp, hardwood pulp, corn fiber and other agricultural sources, and bacterial celluloses.

One method of producing cellulose esters is by esterification. In such a method, the cellulose is mixed with the appropriate organic acids, acid anhydrides, and catalysts and then converted to a cellulose triester. Ester hydrolysis is then performed by adding a water-acid mixture to the cellulose triester, which can be filtered to remove any gel particles or fibers. Water is added to the mixture to precipitate out the cellulose ester. The cellulose ester can be washed with water to remove reaction by-products followed by dewatering and drying.

The cellulose triesters that are hydrolyzed can have three substitutents selected independently from alkanoyls having from 2 to 10 carbon atoms. Examples of cellulose triesters include cellulose triacetate, cellulose tripropionate, and cellulose tributyrate or mixed triesters of cellulose such as cellulose acetate propionate and cellulose acetate butyrate. These cellulose triesters can be prepared by a number of methods known to those skilled in the art. For example, cellulose triesters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Inc., Kingsport, Tenn., U.S.A., typically has a DS from about 2.85 to about 2.95.

After esterification of the cellulose to the triester, part of the acyl substitutents can be removed by hydrolysis or by alcoholysis to give a secondary cellulose ester. Secondary cellulose esters can also be prepared directly with no hydrolysis by using a limiting amount of acylating reagent. This process is particularly useful when the reaction is conducted in a solvent that will dissolve cellulose.

In another embodiment of the invention, low molecular weight mixed cellulose esters can be utilized, such as those disclosed in U.S. Pat. No. 7,585,905, which is incorporated herein by reference to the extent it does not contradict the statements herein.

In one embodiment of the invention, a low molecular weight mixed cellulose ester is utilized that has the following properties: (A) a total DS/AGU of from about 3.08 to about 3.50 with the following substitutions: a DS/AGU of hydroxyl of not more than about 0.70, a DS/AGU of C3/C4 esters from about 0.80 to about 1.40, and a DS/AGU of acetyl of from about 1.20 to about 2.34; an IV of from about 0.05 to about 0.15 dL/g, as measured in a 60/40 (wt./wt.) solution of phenol/tetrachloroethane at 25° C.; a number average molecular weight of from about 1,000 to about 5,600; a weight average molecular weight of from about 1,500 to about 10,000; and a polydispersity of from about 1.2 to about 3.5.

In another embodiment of the invention, a low molecular weight mixed cellulose ester is utilized that has the following properties: a total DS/AGU of from about 3.08 to about 3.50 with the following substitutions: a DS/AGU of hydroxyl of not more than about 0.70; a DS/AGU of C3/C4 esters from about 1.40 to about 2.45, and DS/AGU of acetyl of from about 0.20 to about 0.80; an IV of from about 0.05 to about 0.15 dL/g, as measured in a 60/40 (wt./wt.) solution of phenol/tetrachloroethane at 25° C.; a number average molecular weight of from about 1,000 to about 5,600; a weight average molecular weight of from about 1,500 to about 10,000; and a polydispersity of from about 1.2 to about 3.5.

In yet another embodiment of the invention, a low molecular weight mixed cellulose ester is utilized that has the following properties: a total DS/AGU of from about 3.08 to about 3.50 with the following substitutions: a DS/AGU of hydroxyl of not more than about 0.70; a DS/AGU of C3/C4 esters from about 2.11 to about 2.91, and a DS/AGU of acetyl of from about 0.10 to about 0.50; an IV of from about 0.05 to about 0.15 dL/g, as measured in a 60/40 (wt./wt.) solution of phenol/tetrachloroethane at 25° C.; a number average molecular weight of from about 1,000 to about 5,600; a weight average molecular weight of from about 1,500 to about 10,000; and a polydispersity of from about 1.2 to about 3.5.

In certain embodiments, the cellulose esters utilized in this invention can also contain chemical functionality. In such embodiments, the cellulose esters are described herein as “derivatized,” “modified,” or “functionalized” cellulose esters.

Functionalized cellulose esters are produced by reacting the free hydroxyl groups of cellulose esters with a bifunctional reactant that has one linking group for grafting to the cellulose ester and one functional group to provide a new chemical group to the cellulose ester. Examples of such bifunctional reactants include succinic anhydride, which links through an ester bond and provides acid functionality; mercaptosilanes, which links through alkoxysilane bonds and provides mercapto functionality; and isocyanotoethyl methacrylate, which links through a urethane bond and gives methacrylate functionality.

In one embodiment of the invention, the functionalized cellulose esters comprise at least one functional group selected from the group consisting of unsaturation (double bonds), carboxylic acids, acetoacetate, acetoacetate imide, mercapto, melamine, and long alkyl chains.

Bifunctional reactants to produce cellulose esters containing unsaturation (double bonds) functionality are described in U.S. Pat. Nos. 4,839,230, 5,741,901, 5,871,573, 5,981,738, 4,147,603, 4,758,645, and 4,861,629; all of which are incorporated by reference to the extent they do not contradict the statements herein. In one embodiment, the cellulose esters containing unsaturation are produced by reacting a cellulose ester containing residual hydroxyl groups with an acrylic-based compound and m-isopropyenyl-α,α′-dimethylbenzyl isocyanate. The grafted cellulose ester is a urethane-containing product having pendant (meth)acrylate and α-methylstyrene moieties. In another embodiment, the cellulose esters containing unsaturation are produced by reacting maleic anhydride and a cellulose ester in the presence of an alkaline earth metal or ammonium salt of a lower alkyl monocarboxylic acid catalyst, and at least one saturated monocarboxylic acid have 2 to 4 carbon atoms. In another embodiment, the cellulose esters containing unsaturation are produced from the reaction product of (a) at least one cellulosic polymer having isocyanate reactive hydroxyl functionality and (b) at least one hydroxyl reactive poly(α,β ethylenically unsaturated) isocyanate.

Bifunctional reactants to produce cellulose esters containing carboxylic acid functionality are described in U.S. Pat. Nos. 5,384,163, 5,723,151, and 4,758,645; all of which are incorporated by reference to the extent they do not contradict the statements herein. In one embodiment, the cellulose esters containing carboxylic acid functionality are produced by reacting a cellulose ester and a mono- or di-ester of maleic or furmaric acid, thereby obtaining a cellulose derivative having double bond functionality. In another embodiment, the cellulose esters containing carboxylic acid functionality has a first and second residue, wherein the first residue is a residue of a cyclic dicarboxylic acid anhydride and the second residue is a residue of an oleophilic monocarboxylic acid and/or a residue of a hydrophilic monocarboxylic acid. In yet another embodiment, the cellulose esters containing carboxylic acid functionality are cellulose acetate phthalates, which can be prepared by reacting cellulose acetate with phthalic anhydride.

Bifunctional reactants to produce cellulose esters containing acetoacetate functionality are described in U.S. Pat. No. 5,292,877, which is incorporated by reference to the extent it does not contradict the statements herein. In one embodiment, the cellulose esters containing acetoacetate functionality are produced by contacting: (i) cellulose; (ii) diketene, an alkyl acetoacetate, 2,2,6, trimethyl-4H1,3-dioxin-4-one, or a mixture thereof, and (iii) a solubilizing amount of solvent system comprising lithium chloride plus a carboxamide selected from the group consisting of 1-methyl-2-pyrrolidinone, N,N dimethylacetamide, or a mixture thereof.

Bifunctional reactants to produce cellulose esters containing acetoacetate imide functionality are described in U.S. Pat. No. 6,369,214, which is incorporated by reference to the extent it does not contradict the statements herein. Cellulose esters containing acetoacetate imide functionality are the reaction product of a cellulose ester and at least one acetoacetyl group and an amine functional compound comprising at least one primary amine.

Bifunctional reactants to produce cellulose esters containing mercapto functionality are described in U.S. Pat. No. 5,082,914, which is incorporated by reference to the extent it does not contradict the statements herein. In one embodiment of the invention, the cellulose ester is grafted with a silicon-containing thiol component which is either commercially available or can be prepared by procedures known in the art. Examples of silicon-containing thiol compounds include, but are not limited to, (3-mercaptopropyl)trimethoxysilane, (3-mercaptopropyl)-dimethyl-methoxysilane, (3-mercaptopropyl)dimethoxymethylsilane, (3-mercaptopropyl)dimethylchlorosilane, (3-mercaptopropyl)dimethylethoxysilane, (3-mercaptopropyl)diethyoxy-methylsilane, and (3-mercapto-propyl)triethoxysilane.

Bifunctional reactants to produce cellulose esters containing melamine functionality are described in U.S. Pat. No. 5,182,379, which is incorporated by reference to the extent it does not contradict the statements herein. In one embodiment, the cellulose esters containing melamine functionality are prepared by reacting a cellulose ester with a melamine compound to form a grafted cellulose ester having melamine moieties grafted to the backbone of the anhydroglucose rings of the cellulose ester. In one embodiment, the melamine compound is selected from the group consisting of methylol ethers of melamine and aminoplast carrier elastomers.

Bifunctional reactants to produce cellulose esters containing long alkyl chain functionality are described in U.S. Pat. No. 5,750,677, which is incorporated by reference to the extent it does not contradict the statements herein. In one embodiment, the cellulose esters containing long alkyl chain functionality are produced by reacting cellulose in carboxamide diluents or urea-based diluents with an acylating reagent using a titanium-containing species. Cellulose esters containing long alkyl chain functionality can be selected from the group consisting of cellulose acetate hexanoate, cellulose acetate nonanoate, cellulose acetate laurate, cellulose palmitate, cellulose acetate stearate, cellulose nonanoate, cellulose hexanoate, cellulose hexanoate propionate, and cellulose nonanoate propionate.

In certain embodiments of the invention, the cellulose ester can be modified using one or more plasticizers. The plasticizer can form at least about 1, 2, 5, or 10 weight percent of the cellulose ester composition. Additionally or alternatively, the plasticizer can make up not more than about 60, 50, 40, or 35 weight percent of the cellulose ester composition. In one embodiment, the cellulose ester is a modified cellulose ester that was formed by modifying an initial cellulose ester with a plasticizer.

The plasticizer used for modification can be any that is known in the art that can reduce the melt temperature and/or the melt viscosity of the cellulose ester. The plasticizer can be either monomeric or polymeric in structure. In one embodiment, the plasticizer is at least one selected from the group consisting of a phosphate plasticizer, benzoate plasticizer, adipate plasticizer, a phthalate plasticizer, a glycolic acid ester, a citric acid ester plasticizer, and a hydroxyl-functional plasticizer.

In one embodiment of the invention, the plasticizer can be selected from at least one of the following: triphenyl phosphate, tricresyl phosphate, cresyldiphenyl phosphate, octyldiphenyl phosphate, diphenylbiphenyl phosphate, trioctyl phosphate, tributyl phosphate, diethyl phthalate, dimethoxyethyl phthalate, dimethyl phthalate, dioctyl phthalate, dibutyl phthalate, di-2-ethylhexyl phthalate, butylbenzyl phthalate, dibenzyl phthalate, butyl phthalyl butyl glycolate, ethyl phthalyl ethyl glycolate, methyl phthalyl ethyl glycolate, triethyl citrate, tri-n-butyl citrate, acetyltriethyl citrate, acetyl-tri-n-butyl citrate, and acetyl-tri-n-(2-ethylhexyl)citrate.

In another embodiment of the invention, the plasticizer can be one or more esters comprising (i) at least one acid residue including residues of phthalic acid, adipic acid, trimellitic acid, succinic acid, benzoic acid, azelaic acid, terephthalic acid, isophthalic acid, butyric acid, glutaric acid, citric acid, and/or phosphoric acid; and (ii) alcohol residues comprising one or more residues of an aliphatic, cycloaliphatic, or aromatic alcohol containing up to about 20 carbon atoms.

In another embodiment of the invention, the plasticizer can comprise alcohol residues containing residues selected from the following: stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol.

In another embodiment of the invention, the plasticizer can be selected from at least one of the following: benzoates, phthalates, phosphates, arylene-bis(diaryl phosphate), and isophthalates. In another embodiment, the plasticizer comprises diethylene glycol dibenzoate, abbreviated herein as “DEGDB”.

In another embodiment of the invention, the plasticizer can comprise aliphatic polyesters containing C2-10 diacid residues such as, for example, malonic acid, succinic acid, glutaric acid, adipic acid, pimelic acid, suberic acid, azelaic acid, and sebacic acid; and C2-10 diol residues.

In another embodiment, the plasticizer can comprise diol residues which can be residues of at least one of the following C2-C10 diols: ethylene glycol, diethylene glycol, 1,2-propylene glycol, 1,3-propylene glycol, 1,2-butylene glycol, 1,3-butylene glycol, 1,4-butylene glycol, neopentyl glycol, 1,5-pentanediol, 1,6hexanediol, 1,5-pentylene glycol, triethylene glycol, and tetraethylene glycol.

In another embodiment of the invention, the plasticizer can include polyglycols, such as, for example, polyethylene glycol, polypropylene glycol, and polybutylene glycol. These can range from low molecular weight dimers and trimers to high molecular weight oligomers and polymers. In one embodiment, the molecular weight of the polyglycol can range from about 200 to about 2,000.

In another embodiment of the invention, the plasticizer comprises at least one of the following: Resoflex® R296 plasticizer, Resoflex® 804 plasticizer, SHP (sorbitol hexapropionate), XPP (xylitol pentapropionate), XPA (xylitol pentaacetate), GPP (glucose pentaacetate), GPA (glucose pentapropionate), and APP (arabitol pentapropionate).

In another embodiment of the invention, the plasticizer comprises one or more of: A) from about 5 to about 95 weight percent of a C2-C12 carbohydrate organic ester, wherein the carbohydrate comprises from about 1 to about 3 monosaccharide units; and B) from about 5 to about 95 weight percent of a C2-C12 polyol ester, wherein the polyol is derived from a C5 or C6 carbohydrate. In one embodiment, the polyol ester does not comprise or contain a polyol acetate or polyol acetates.

In another embodiment, the plasticizer comprises at least one carbohydrate ester and the carbohydrate portion of the carbohydrate ester is derived from one or more compounds selected from the group consisting of glucose, galactose, mannose, xylose, arabinose, lactose, fructose, sorbose, sucrose, cellobiose, cellotriose, and raffinose.

In another embodiment of the invention, the plasticizer comprises at least one carbohydrate ester and the carbohydrate portion of the carbohydrate ester comprises one or more of α-glucose pentaacetate, β-glucose pentaacetate, α-glucose pentapropionate, β-glucose pentapropionate, α-glucose pentabutyrate, and β-glucose pentabutyrate.

In another embodiment, the plasticizer comprises at least one carbohydrate ester and the carbohydrate portion of the carbohydrate ester comprises an α-anomer, a β-anomer, or a mixture thereof.

In another embodiment of the invention, the plasticizer can be a solid, non-crystalline carrier elastomer. These carrier elastomers can contain some amount of aromatic or polar functionality and can lower the melt viscosity of the cellulose esters. In one embodiment of the invention, the plasticizer can be a solid, non-crystalline compound, such as, for example, a rosin; a hydrogenated rosin; a stabilized rosin, and their monofunctional alcohol esters or polyol esters; a modified rosin including, but not limited to, maleic- and phenol-modified rosins and their esters; terpene elastomers; phenol-modified terpene elastomers; coumarin-indene elastomers; phenolic elastomers; alkylphenol-acetylene elastomers; and phenol-formaldehyde elastomers.

In another embodiment of the invention, the plasticizer can be a tackifier resin. Any tackifier known to a person of ordinary skill in the art may be used in the cellulose ester/elastomer compositions. Tackifiers suitable for the compositions disclosed herein can be solids, semi-solids, or liquids at room temperature. Non-limiting examples of tackifiers include (1) natural and modified rosins (e.g., gum rosin, wood rosin, tall oil rosin, distilled rosin, hydrogenated rosin, dimerized rosin, and polymerized rosin); (2) glycerol and pentaerythritol esters of natural and modified rosins (e.g., the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin); (3) copolymers and terpolymers of natured terpenes (e.g., styrene/terpene and alpha methyl styrene/terpene); (4) polyterpene resins and hydrogenated polyterpene resins; (5) phenolic modified terpene resins and hydrogenated derivatives thereof (e.g., the resin product resulting from the condensation, in an acidic medium, of a bicyclic terpene and a phenol); (6) aliphatic or cycloaliphatic hydrocarbon resins and the hydrogenated derivatives thereof (e.g., resins resulting from the polymerization of monomers consisting primarily of olefins and diolefins); (7) aromatic hydrocarbon resins and the hydrogenated derivatives thereof; and (8) aromatic modified aliphatic or cycloaliphatic hydrocarbon resins and the hydrogenated derivatives thereof; and combinations thereof.

In another embodiment of the invention, the tackifier resins include rosin-based tackifiers (e.g. AQUATAC® 9027, AQUATAC® 4188, SYLVALITE®, SYLVATAC® and SYL V AGUM® rosin esters from Arizona Chemical, Jacksonville, Fla.). In other embodiments, the tackifiers include polyterpenes or terpene resins (e.g., SYLVARES® 15 terpene resins from Arizona Chemical, Jacksonville, Fla.). In other embodiments, the tackifiers include aliphatic hydrocarbon resins such as resins resulting from the polymerization of monomers consisting of olefins and diolefins (e.g., ESCOREZ® 1310LC, ESCOREZ® 2596 from ExxonMobil Chemical Company, Houston, Tex. or PICCOTAC® 1095 from Eastman Chemical Company, Kingsport, Term.) and the hydrogenated derivatives 20 thereof; alicyclic petroleum hydrocarbon resins and the hydrogenated derivatives thereof (e.g. ESCOREZ® 5300 and 5400 series from ExxonMobil Chemical Company; EASTOTAC® resins from Eastman Chemical Company). In some embodiments, the tackifiers include hydrogenated cyclic hydrocarbon resins (e.g. REGALREZ® and REGALITE® resins from Eastman Chemical Company). In further embodiments, the tackifiers are modified with tackifier modifiers including aromatic compounds (e.g., ESCOREZ® 2596 from ExxonMobil Chemical Company or PICCOTAC® 7590 from Eastman Chemical Company) and low softening point resins (e.g., AQUATAC 5527 from Arizona Chemical, Jacksonville, Fla.). In some embodiments, the tackifier is an aliphatic hydrocarbon resin having at least five carbon atoms.

In certain embodiments of the present invention, the cellulose ester can be modified using one or more compatibilizers. The compatibilizer can comprise at least about 1, 2, 3, or 5 weight percent of the cellulose ester composition. Additionally or alternatively, the compatibilizer can comprise not more than about 40, 30, 25, or 20 weight percent of the cellulose ester composition.

The compatibilizer can be either a non-reactive compatibilizer or a reactive compatibilizer. The compatibilizer can enhance the ability of the cellulose ester to reach a desired small particle size thereby improving the dispersion of the cellulose ester into an elastomer. The compatibilizers used can also improve mechanical and physical properties of the elastomeric compositions by enhancing the interfacial interaction/bonding between the cellulose ester and the elastomer.

When non-reactive compatibilizers are utilized, the compatibilizer can contain a first segment that is compatible with the cellulose ester and a second segment that is compatible with the elastomer. In this case, the first segment contains polar functional groups, which provide compatibility with the cellulose ester, including, but not limited to, such polar functional groups as ethers, esters, amides, alcohols, amines, ketones, and acetals. The first segment may include oligomers or polymers of the following: cellulose esters; cellulose ethers; polyoxyalkylene, such as, polyoxyethylene, polyoxypropylene, and polyoxybutylene; polyglycols, such as, polyethylene glycol, polypropylene glycol, and polybutylene glycol; polyesters, such as, polycaprolactone, polylactic acid, aliphatic polyesters, and aliphatic-aromatic copolyesters; polyacrylates and polymethacrylates; polyacetals; polyvinylpyrrolidone; polyvinyl acetate; and polyvinyl alcohol. In one embodiment, the first segment is polyoxyethylene or polyvinyl alcohol.

The second segment can be compatible with the elastomer and contain nonpolar groups. The second segment can contain saturated and/or unsaturated hydrocarbon groups. In one embodiment, the second segment can be an oligomer or a polymer. In another embodiment, the second segment of the non-reactive compatibilizer is selected from the group consisting of polyolefins, polydienes, polyaromatics, and copolymers.

In one embodiment, the first and second segments of the non-reactive compatibilizers can be in a diblock, triblock, branched, or comb structure. In this embodiment, the molecular weight of the non-reactive compatibilizers can range from about 300 to about 20,000, 500 to about 10,000, or 1,000 to about 5,000. The segment ratio of the non-reactive compatibilizers can range from about 15 to about 85 percent polar first segments to about 15 to about 85 percent nonpolar second segments.

Examples of non-reactive compatibilizers include, but are not limited to, ethoxylated alcohols, ethoxylated alkylphenols, ethoxylated fatty acids, block polymers of propylene oxide and ethylene oxide, polyglycerol esters, polysaccharide esters, and sorbitan esters. Examples of ethoxylated alcohols are C11-C15 secondary alcohol ethoxylates, polyoxyethylene cetyl ether, polyoxyethylene stearyl ether, and C12-C14 natural liner alcohol ethoxylated with ethylene oxide. C11-C15 secondary ethyoxylates can be obtained as Dow Tergitol® 15S from the Dow Chemical Company. Polyoxyethlene cetyl ether and polyoxyethylene stearyl ether can be obtained from ICI Surfactants under the Brij® series of products. C12-C14 natural linear alcohol ethoxylated with ethylene oxide can be obtained from Hoechst Celanese under the Genapol® series of products. Examples of ethoxylated alkylphenols include octylphenoxy poly(ethyleneoxy)ethanol and nonylphenoxy poly(ethyleneoxy)ethanol. Octylphenoxy poly(ethyleneoxy)ethanol can be obtained as Igepal® CA series of products from Rhodia, and nonylphenoxy poly(ethyleneoxy)ethanol can be obtained as Igepal CO series of products from Rhodia or as Tergitol® NP from Dow Chemical Company. Ethyoxylated fatty acids include polyethyleneglycol monostearate or monolaruate which can be obtained from Henkel under the Nopalcol® series of products. Block polymers of propylene oxide and ethylene oxide can be obtained under the Pluronic® series of products from BASF. Polyglycerol esters can be obtained from Stepan under the Drewpol® series of products. Polysaccharide esters can be obtained from Henkel under the Glucopon® series of products, which are alkyl polyglucosides. Sorbitan esters can be obtained from ICI under the Tween® series of products.

In another embodiment of the invention, the non-reactive compatibilizers can be synthesized in situ in the cellulose ester composition or the cellulose ester/primary elastomer composition by reacting cellulose ester-compatible compounds with elastomer-compatible compounds. These compounds can be, for example, telechelic oligomers, which are defined as prepolymers capable of entering into further polymerization or other reaction through their reactive end groups. In one embodiment of the invention, these in situ compatibilizers can have higher molecular weight from about 10,000 to about 1,000,000.

In another embodiment of the invention, the compatibilizer can be reactive. The reactive compatibilizer comprises a polymer or oligomer compatible with one component of the composition and functionality capable of reacting with another component of the composition. There are two types of reactive compatibilizers. The first reactive compatibilizer has a hydrocarbon chain that is compatible with a nonpolar elastomer and also has functionality capable of reacting with the cellulose ester. Such functional groups include, but are not limited to, carboxylic acids, anhydrides, acid chlorides, epoxides, and isocyanates. Specific examples of this type of reactive compatibilizer include, but are not limited to: long chain fatty acids, such as stearic acid (octadecanoic acid); long chain fatty acid chlorides, such as stearoyl chloride (octadecanoyl chloride); long chain fatty acid anhydrides, such as stearic anhydride (octadecanoic anhydride); epoxidized oils and fatty esters; styrene maleic anhydride copolymers; maleic anhydride grafted polypropylene; copolymers of maleic anhydride with olefins and/or acrylic esters, such as terpolymers of ethylene, acrylic ester and maleic anhydride; and copolymers of glycidyl methacrylate with olefins and/or acrylic esters, such as terpolymers of ethylene, acrylic ester, and glycidyl methacrylate.

Reactive compatibilizers can be obtained as SMA® 3000 styrene maleic anhydride copolymer from Sartomer/Cray Valley, Eastman G-3015® maleic anhydride grafted polypropylene from Eastman Chemical Company, Epolene® E-43 maleic anhydride grafted polypropylene obtained from Westlake Chemical, Lotader® MAH 8200 random terpolymer of ethylene, acrylic ester, and maleic anhydride obtained from Arkema, Lotader® GMA AX 8900 random terpolymer of ethylene, acrylic ester, and glycidyl methacrylate, and Lotarder® GMA AX 8840 random terpolymer of ethylene, acrylic ester, and glycidyl methacrylate.

The second type of reactive compatibilizer has a polar chain that is compatible with the cellulose ester and also has functionality capable of reacting with a nonpolar elastomer. Examples of these types of reactive compatibilizers include cellulose esters or polyethylene glycols with olefin or thiol functionality. Reactive polyethylene glycol compatibilizers with olefin functionality include, but are not limited to, polyethylene glycol allyl ether and polyethylene glycol acrylate. An example of a reactive polyethylene glycol compatibilizer with thiol functionality includes polyethylene glycol thiol. An example of a reactive cellulose ester compatibilizer includes mercaptoacetate cellulose ester.

### (B) Primary Elastomers

The elastomeric composition of the present invention comprises at least one primary elastomer. The term “elastomer,” as used herein, can be used interchangeably with the term “rubber.” Due to the wide applicability of the process described herein, the cellulose esters can be employed with virtually any type of primary elastomer. For instance, the primary elastomers utilized in this invention can comprise a natural rubber, a modified natural rubber, a synthetic rubber, and mixtures thereof.

In certain embodiments of the present invention, at least one of the primary elastomers is a non-polar elastomer. For example, a non-polar primary elastomer can comprise at least about 90, 95, 98, 99, or 99.9 weight percent of non-polar monomers. In one embodiment, the non-polar primary elastomer is primarily based on a hydrocarbon. Examples of non-polar primary elastomers include, but are not limited to, natural rubber, polybutadiene rubber, polyisoprene rubber, styrene-butadiene rubber, polyolefins, ethylene propylene diene monomer (EPDM) rubber, and polynorbornene rubber. Examples of polyolefins include, but are not limited to, polybutylene, polyisobutylene, and ethylene propylene rubber.

In certain embodiments, the primary elastomer comprises a natural rubber, a styrene-butadiene rubber, and/or a polybutadiene rubber.

In certain embodiments, the primary elastomer contains little or no nitrile groups. As used herein, the primary elastomer is considered a “non-nitrile” primary elastomer when nitrile monomers make up less than 10 weight percent of the primary elastomer. In one embodiment, the primary elastomer contains no nitrile groups.

### (C) Carrier Elastomers

In certain embodiments, the cellulose esters are mixed with at least one carrier elastomer to produce the cellulose ester concentrate. The cellulose ester concentrate can subsequently be blended with the primary elastomer to form an elastomeric composition. Thus, in such embodiments, the elastomeric composition can comprise at least one carrier elastomer.

The carrier elastomer can be virtually any uncured elastomer that is compatible with the primary elastomer and that can be processed at a temperature exceeding 160° C. The carrier elastomer can comprise, for example, styrene block copolymers, polybutadienes, natural rubbers, synthetic rubbers, acrylics, maleic anhydride modified styrenics, recycled rubber, crumb rubber, powdered rubber, isoprene rubber, nitrile rubber, and combinations thereof. The styrene block copolymers can include, for example, styrene-butadiene block copolymers and styrene ethylene-butylene block copolymers having a styrene content of at least about 5, 10, or 15 weight percent and/or not more than about 40, 35, or 30 weight percent. In one embodiment, the carrier elastomers have a Tg that is less than the Tg of the cellulose ester.

In certain embodiments, the carrier elastomer comprises styrene block copolymers, polybutadienes, natural rubbers, synthetic rubbers, acrylics, maleic anhydride modified styrenics, and combinations thereof. In one embodiment, the carrier elastomer comprises 1,2polybutadiene. In another embodiment, the carrier elastomer comprises a styrene block copolymer. In yet another embodiment, the carrier elastomer comprises a maleic anhydride-modified styrene ethylene-butylene elastomer.

In certain embodiments, the carrier elastomer contains little or no nitrile groups. As used herein, the carrier elastomer is considered a “non-nitrile” carrier elastomer when nitrile monomers make up less than 10 weight percent of the carrier elastomer. In one embodiment, the carrier elastomer contains no nitrile groups.

In one embodiment, the carrier elastomer is the same as the primary elastomer. In another embodiment, the carrier elastomer is different from the primary elastomer.

### (D) Fillers

In certain embodiments, the cellulose ester concentrate and/or the elastomeric composition can comprise one or more fillers.

The fillers can comprise any filler that can improve the thermophysical properties of the elastomeric composition (e.g., modulus, strength, and expansion coefficient). For example, the fillers can comprise silica, carbon black, clay, alumina, talc, mica, discontinuous fibers including cellulose fibers and glass fibers, aluminum silicate, aluminum trihydrate, barites, feldspar, nepheline, antimony oxide, calcium carbonate, kaolin, and combinations thereof. In one embodiment, the fillers comprise an inorganic and nonpolymeric material. In another embodiment, the fillers comprise silica and/or carbon black. In yet another embodiment, the fillers comprise silica.

In certain embodiments, the elastomeric composition can comprise at least about 5, 10, 15, 20, 25, 30, 35, 40, 45, or 50 phr of one or more fillers, based on the total weight of the elastomers. Additionally or alternatively, the elastomeric composition can comprise not more than about 150, 140, 130, 120, 110, 100, 90, 80, 70, or 60 phr of one or more fillers, based on the total weight of the elastomers.

In certain embodiments, the elastomeric composition is a highly-filled elastomeric composition. As used herein, a “highly-filled” elastomeric composition comprises at least about 60 phr of one or more fillers, based on the total weight of the elastomers. In one embodiment, a highly-filled elastomeric composition comprises at least about 65, 70, 75, 80, 85, 90, or 95 phr of one or more fillers, based on the total weight of the elastomers. Additionally or alternatively, the highly-filled elastomeric composition can comprise not more than about 150, 140, 130, 120, 110, or 100 phr of one or more fillers, based on the total weight of the elastomers.

### (E) Optional Additives

In certain embodiments, the cellulose ester concentrate and/or the elastomeric composition can comprise one or more additives.

In certain embodiments, the elastomeric composition can comprise at least about 1, 2, 5, 10, or 15 phr of one or more additives, based on the total weight of the elastomers. Additionally or alternatively, the elastomeric composition can comprise not more than about 70, 50, 40, 30, or phr of one or more additives, based on the total weight of the elastomers.

The additives can comprise, for example, processing aids, carrier elastomers, tackifiers, lubricants, oils, waxes, surfactants, stabilizers, UV absorbers/inhibitors, pigments, antioxidants, extenders, reactive coupling agents, and/or branchers. In one embodiment, the additives comprise one or more cellulose ethers, starches, and/or derivatives thereof. In such an embodiment, the cellulose ethers, starches and/or derivatives thereof can include, for example, amylose, acetoxypropyl cellulose, amylose triacetate, amylose tributyrate, amylose tricabanilate, amylose tripropionate, carboxymethyl amylose, ethyl cellulose, ethyl hydroxyethyl cellulose, hydroxyethyl cellulose, methyl cellulose, sodium carboxymethyl cellulose, and sodium cellulose xanthanate.

In one embodiment, the additives comprise a non-cellulose ester processing aid. The non-cellulose ester processing aid can comprise, for example, a processing oil, starch, starch derivatives, and/or water. In such an embodiment, the elastomeric composition can comprise less than about 10, 5, 3, or 1 phr of the non-cellulose ester processing aid, based on the total weight of the elastomers. Additionally or alternatively, the elastomeric composition can exhibit a weight ratio of cellulose ester to non-cellulose ester processing aid of at least about 0.5:1, 1:1, 2:1, 3:1, 4:1, 5:1, 8:1, or 10:1.

In another embodiment, the elastomeric composition can comprise a starch and/or its derivatives. In such an embodiment, the elastomeric composition can comprise less than 10, 5, 3, or 1 phr of starch and its derivatives, based on the total weight of the elastomers. Additionally or alternatively, the elastomeric composition can exhibit a weight ratio of cellulose ester to starch of at least about 3:1, 4:1, 5:1, 8:1, or 10:1.

### (F) Process for Producing Elastomeric Compositions

The process of the present invention comprises mixing a cellulose ester with a carrier elastomer to produce a cellulose ester concentrate (i.e., a cellulose ester masterbatch), and then blending the cellulose ester concentrate with a primary elastomer to produce the elastomeric composition. This process may also be referred to as a “masterbatch process.” One advantage of this masterbatch process is that it can more readily disperse cellulose esters having a higher Tg throughout the elastomeric composition.

In certain embodiments, the masterbatch process comprises the following steps: a) mixing at least one cellulose ester with at least one carrier elastomer for a sufficient time and temperature to mix the cellulose ester and the carrier elastomer to produce a cellulose ester concentrate; and b) blending the cellulose ester concentrate with at least one primary elastomer to produce the elastomeric composition. A sufficient temperature for mixing the cellulose ester with the carrier elastomer can be the flow temperature of the cellulose ester, which is higher than the Tg of the cellulose ester by at least about 10° C., 15° C., 20° C., 25° C., 30° C., 35° C., 40° C., 45° C., or 50° C. In one embodiment, at least a portion of the mixing of step (a) occurs at a temperature that is at least 10° C., 15° C., 20° C., 30° C., 40° C., or 50° C. greater than the temperature of the blending of step (b).

In certain embodiments of the masterbatch process, the cellulose ester has a Tg of at least about 90° C., 95° C., 100° C., 105° C., 110° C., 115° C., or 120° C. Additionally or alternatively, the cellulose ester can have a Tg of not more than about 200° C., 180° C., 170° C., 160° C., or 150° C.

In certain embodiments, at least a portion of the mixing of the cellulose ester and the carrier elastomer occurs at a temperature of at least about 150° C., 160° C., 170° C., 180° C., 190° C., 200° C., or 210° C. Additionally or alternatively, at least a portion of the mixing of the cellulose ester and the carrier elastomer occurs at a temperature below 260° C., 250° C., 240° C., 230° C., or 220° C.

In certain embodiments, at least a portion of the blending of the cellulose ester concentrate and the primary elastomer occurs at a temperature that will not degrade the primary elastomer. For instance, at least a portion of the blending can occur at a temperature of not more than about 180° C., 170° C., 160° C., or 150° C.

In certain embodiments, the melt viscosity ratio of the cellulose ester to the carrier elastomer is at least about 0.1, 0.2, 0.3, 0.5, 0.8, or 1.0 as measured at 170° C. and a shear rate of 400 s⁻¹. Additionally or alternatively, the melt viscosity ratio of the cellulose ester to the carrier elastomer is not more than about 2, 1.8, 1.6, 1.4, or 1.2 as measured at 170° C. and a shear rate of 400 s⁻¹.

In certain embodiments, the melt viscosity ratio of the cellulose ester concentrate to the primary elastomer is at least about 0.1, 0.2, 0.3, 0.5, 0.8, or 1.0 as measured at 160° C. and a shear rate of 200 s⁻¹. Additionally or alternatively, the melt viscosity ratio of the cellulose ester concentrate to the primary elastomer is not more than about 2, 1.8, 1.6, 1.4, or 1.2 as measured at as measured at 160° C. and a shear rate of 200 s⁻¹.

In certain embodiments, the cellulose ester exhibits a melt viscosity of at least about 75,000, 100,000, or 125,000 poise as measured at 170° C. and a shear rate of 1 rad/sec. Additionally or alternatively, the cellulose ester can exhibit a melt viscosity of not more than about 1,000,000, 900,000, or 800,000 poise as measured at 170° C. and a shear rate of 1 rad/sec. In another embodiment, the carrier elastomer exhibits a melt viscosity of at least about 75,000, 100,000, or 125,000 poise as measured at 170° C. and a shear rate of 1 rad/sec. Additionally or alternatively, the carrier elastomer can exhibit a melt viscosity of not more than about 2,000,000, 1,750,000, or 1,600,000 poise as measured at 170° C. and a shear rate of 1 rad/sec.

In certain embodiments, the cellulose ester exhibits a melt viscosity of at least about 25,000, 40,000, or 65,000 poise as measured at 170° C. and a shear rate of 10 rad/sec. Additionally or alternatively, the cellulose ester can exhibit a melt viscosity of not more than about 400,000, 300,000, or 200,000 poise as measured at 170° C. and a shear rate of 10 rad/sec. In another embodiment, the carrier elastomer exhibits a melt viscosity of at least about 20,000, 30,000, or 40,000 poise as measured at 170° C. and a shear rate of 10 rad/sec. Additionally or alternatively, the carrier elastomer can exhibit a melt viscosity of not more than about 500,000, 400,000, or 300,000 poise as measured at 170° C. and a shear rate of 10 rad/sec.

In certain embodiments, the cellulose ester exhibits a melt viscosity of at least about 10,000, 15,000, or 20,000 poise as measured at 170° C. and a shear rate of 100 rad/sec. Additionally or alternatively, the cellulose ester can exhibit a melt viscosity of not more than about 100,000, 75,000, or 50,000 poise as measured at 170° C. and a shear rate of 100 rad/sec. In another embodiment, the carrier elastomer exhibits a melt viscosity of at least about 10,000, 15,000, or 20,000 poise as measured at 170° C. and a shear rate of 100 rad/sec. Additionally or alternatively, the carrier elastomer can exhibit a melt viscosity of not more than about 100,000, 75,000, or 50,000 poise as measured at 170° C. and a shear rate of 100 rad/sec.

In certain embodiments, the cellulose ester exhibits a melt viscosity of at least about 2,000, 5,000, or 8,000 poise as measured at 170° C. and a shear rate of 400 rad/sec. Additionally or alternatively, the cellulose ester can exhibit a melt viscosity of not more than about 30,000, 25,000, or 20,000 poise as measured at 170° C. and a shear rate of 400 rad/sec. In another embodiment, the carrier elastomer exhibits a melt viscosity of at least about 1,000, 4,000, or 7,000 poise as measured at 170° C. and a shear rate of 400 rad/sec. Additionally or alternatively, the carrier elastomer can exhibit a melt viscosity of not more than about 30,000, 25,000, or 20,000 poise as measured at 170° C. and a shear rate of 400 rad/sec.

The fillers and/or additives can be added or combined in any order or step during the masterbatch process. In one embodiment, the cellulose ester can be modified with a plasticizer and/or compatibilizer prior to forming the cellulose ester concentrate.

In certain embodiments, at least a portion of the cellulose ester concentrate can be subjected to fibrillation prior to being blended with the primary elastomer. In such embodiments, the resulting fibrils of the cellulose ester concentrate can have an aspect ratio of at least about 1.25:1, 1.3:1, 1.4:1, or 1.5:1. In an alternative embodiment, at least a portion of the cellulose ester concentrate can be pelletized or granulated prior to being blended with the primary elastomer.

In certain embodiments, the cellulose ester concentrate can comprise at least about 10, 15, 20, 25, 30, 35, or 40 weight percent of at least one cellulose ester. Additionally or alternatively, the cellulose ester concentrate can comprise not more than about 90, 85, 80, 75, 70, 65, 60, 55, or 50 weight percent of at least one cellulose ester. In one embodiment, the cellulose ester concentrate can comprise at least about 10, 15, 20, 25, 30, 35, or 40 weight percent of at least one carrier elastomer. Additionally or alternatively, the cellulose ester concentrate can comprise not more than about 90, 85, 80, 75, 70, 65, 60, 55, or 50 weight percent of at least one carrier elastomer.

During the masterbatch process, the cellulose esters can effectively soften and/or melt, thus allowing the cellulose esters to form into sufficiently small particle sizes under the specified mixing and blending conditions. In such an embodiment, due to the small particle sizes, the cellulose esters can be thoroughly dispersed throughout the elastomeric composition with minimal additional mixing. Hence they can be added to the primary elastomer late in the overall mixing process if desired and therefore be “decoupled” from the mixing of other ingredients into the rubber.

. In one embodiment, subsequent to forming the cellulose ester concentrate and/or elastomeric composition, the particles of cellulose ester therein have a spherical or near-spherical shape. As used herein, a “near-spherical” shape is understood to include particles having a cross-sectional aspect ratio of less than 2:1. In more particular embodiments, the spherical and near-spherical particles have a cross-sectional aspect ratio of less than 1.5:1, 1.2:1, or 1.1:1. The “cross-sectional aspect ratio” as used herein is the ratio of the longer dimension of the particle's cross-section relative to its shorter dimension. In a further embodiment, at least about 75, 80, 85, 90, 95, or 99.9 percent of the particles of cellulose esters in the elastomeric composition have a cross-sectional aspect ratio of not more than about 1.5:1, 1.2:1, or 1.1:1.

In certain embodiments, at least about 75, 80, 85, 90, 95, or 99.9 percent of the cellulose ester particles have a diameter of not more than about 10, 8, 5, 4, 3, 2, or 1 μm subsequent to blending the cellulose ester concentrate with the primary elastomer.

In certain embodiments, the cellulose esters added at the beginning of the masterbatch process are in the form of a powder having particle sizes ranging from 200 to 400 μm. In such an embodiment, subsequent to blending the cellulose ester concentrate with the primary elastomer, the particle sizes of the cellulose ester can decrease by at least about 50, 75, 90, 95, or 99 percent relative to their particle size before the masterbatch process.

In certain embodiments, the fillers can have a particle size that is considerably smaller than the size of the cellulose ester particles. For instance, the fillers can have an average particle size that is not more than about 50, 40, 30, 20, or 10 percent of the average particle size of the cellulose ester particles in the elastomeric composition.

In certain embodiments, the cellulose ester fillers will have a high enough Tg such that they do not soften and flow during subsequent mixing with the primary elastomer. In this embodiment, the cellulose ester particles behave as solid particles in the final mixing process.

The elastomeric compositions produced using the masterbatch process can be subjected to curing to thereby produce a cured elastomeric composition. The curing can be accomplished using any conventional method, such as curing under conditions of elevated temperature and pressure for a suitable period of time. For example, the curing process can involve subjecting the elastomeric composition to a temperature of at least 160° C. over a period of at least 15 minutes. Examples of curing systems that can be used include, but are not limited to, sulfur-based systems, resin-curing systems, soap/sulfur curing systems, urethane crosslinking agents, bisphenol curing agents, silane crosslinking, isocyanates, poly-functional amines, high-energy radiation, metal oxide crosslinking, and/or peroxide cross-linking.

The mixing and blending stages of the masterbatch process can be accomplished by any method known in the art that is sufficient to mix cellulose esters and elastomers. Examples of mixing equipment include, but are not limited to, Banbury mixers, Brabender mixers, planetary mixers, roll mills, single screw extruders, and twin screw extruders. The shear energy during the mixing is dependent on the combination of equipment, blade design, rotation speed (rpm), and mixing time. The shear energy should be sufficient for breaking down softened/melted cellulose ester to a small enough size to disperse the cellulose ester throughout the elastomers. For example, when a Banbury mixer is utilized, the shear energy and time of mixing can range from about 5 to about 15 minutes at 100 rpms. In certain embodiments of the present invention, at least a portion of the blending and/or mixing stages discussed above can be carried out at a shear rate of at least about 50, 75, 100, 125, or 150 s⁻¹. Additionally or alternatively, at least a portion of the blending and/or mixing stages discussed above can be carried out at a shear rate of not more than about 1,000, 900, 800, 600, or 550 s⁻¹.

It is known in the art that the efficiency of mixing two or more viscoelastic materials can depend on the ratio of the viscosities of the viscoelastic materials. For a given mixing equipment and shear rate range, the viscosity ratio of the dispersed phase (cellulose ester, fillers, and additives) and continuous phase (primary elastomer) should be within specified limits for obtaining adequate particle size. In one embodiment of the invention where low shear rotational shearing equipment is utilized, such as, Banbury and Brabender mixers, the viscosity ratio of the dispersed phase (e.g., cellulose ester, fillers, and additives) to the continuous phase (e.g., primary elastomer) can range from about 0.001 to about 5, from about 0.01 to about 5, and from about 0.1 to about 3. In yet another embodiment of the invention where high shear rotational/extensional shearing equipment is utilized, such as, twin screw extruders, the viscosity ratio of the dispersed phase (e.g., cellulose ester, fillers, and additives) to the continuous phase (e.g., primary elastomer) can range from about 0.001 to about 500 and from about 0.01 to about 100.

It is also known in the art that when mixing two or more viscoelastic materials, the difference between the interfacial energy of the two viscoelastic materials can affect the efficiency of mixing. Mixing can be more efficient when the difference in the interfacial energy between the materials is minimal. In one embodiment of the invention, the surface tension difference between the dispersed phase (e.g., cellulose ester, fillers, and additives) and continuous phase (e.g., primary elastomer) is less than about 20 dynes/cm, less than 10 dynes/cm, or less than 5 dynes/cm.

### (G) Elastomeric Compositions

The elastomeric compositions of the present invention can exhibit a number of improvements associated with processability, strength, modulus, and elasticity.

In certain embodiments, the uncured elastomeric composition exhibits a Mooney Viscosity as measured at 100° C. and according to ASTM D 1646 of not more than about 110, 105, 100, 95, 90, or 85 AU. A lower Mooney Viscosity makes the uncured elastomeric composition easier to process. In another embodiment, the uncured elastomeric composition exhibits a Phillips Dispersion Rating of at least 6.

In certain embodiments, the uncured elastomeric composition exhibits a scorch time of at least about 1.8, 1.9, 2.0, 2.1, or 2.2 Ts2, min. A longer scorch time enhances processability in that it provides a longer time to handle the elastomeric composition before curing starts. The scorch time of the samples was tested using a cure rheometer (Oscillating Disk Rheometer (ODR)) and was performed according to ASTM D 2084. As used herein, “ts2” is the time it takes for the torque of the rheometer to increase 2 units above the minimum value and “tc90” is the time to it takes to reach 90 weight percent of the difference between minimum to maximum torque. In another embodiment, the uncured elastomeric composition exhibits a cure time of not more than about 15, 14, 13, 12, 11, or 10 tc90, min. A shorter cure time indicates improved processability because the elastomeric compositions can be cured at a faster rate, thus increasing production.

In certain embodiments, the cured elastomeric composition exhibits a Dynamic Mechanical Analysis (“DMA”) strain sweep modulus as measured at 5% strain and 30° C. of at least about 1,400,000, 1,450,000, 1,500,000, 1,600,000, 1,700,000, or 1,800,000 Pa. A higher DMA strain sweep modulus indicates a higher modulus/hardness. The DMA Strain Sweep is tested using a Metravib DMA150 dynamic mechanical analyzer under 0.001 to 0.5 dynamic strain at 13 points in evenly spaced log steps at 30° C. and 10 Hz.

In certain embodiments, the cured elastomeric composition exhibits a molded groove tear as measured according to ASTM D624 of at least about 80, 100, 120, 125, 130, 140, 150, 155, 160, 165, or 170 lbf/in.

In certain embodiments, the cured elastomeric composition exhibits a peel tear as measured according to ASTM D1876-01 of at least about 80, 85, 90, 95, 100, 110, 120, or 130 lbf/in.

In certain embodiments, the cured elastomeric composition exhibits a break strain as measured according to ASTM D412 of at least about 360, 380, 400, 420, 425, or 430 percent. In another embodiment, the cured elastomer composition exhibits a break stress as measured according to ASTM D412 of at least 2,000, 2,200, 2,400, 2,600, 2,800, 2,900, or 3,000 psi. The break strain and break stress are both indicators of the toughness and stiffness of the elastomeric compositions.

In certain embodiments, the cured elastomeric composition exhibits a tan delta at 0° C. and 5% strain in tension of not more than about 0.100, 0.105, 0.110, or 0.115. In another embodiment, the cured elastomeric composition exhibits a tan delta at 30° C. and 5% strain in shear of not more than about 0.36, 0.30, 0.25, 0.24, 0.23, 0.22, or 0.21. The tan deltas were measured using a TA Instruments dynamic mechanical analyzer to complete temperature sweeps using tensile geometry. The tan deltas (=E″/E′) (storage modulus (E′) and loss modulus (E″)) were measured as a function of temperature from −80° C. to 120° C. using 10 Hz frequency, 5% static, and 0.2% dynamic strain.

In certain embodiments, the cured elastomeric composition exhibits an adhesion strength at 100° C. of at least about 30, 35, 40, or 45 lbf/in. The adhesion strength at 100° C. is measured using 180-degree T-peel geometry.

In certain embodiments, the cured elastomeric composition exhibits a Shore A hardness of at least about 51, 53, 55, or 57. The Shore A hardness is measured according to ASTM D2240.

### (H) Products Incorporating the Elastomeric Compositions

The elastomeric compositions of the present invention can be incorporated into various types of end products.

In certain embodiments, the elastomeric composition is formed into a tire and/or a tire component. The tire component can comprise, for example, tire tread, subtread, undertread, body plies, belts, overlay cap plies, belt wedges, shoulder inserts, tire apex, tire sidewalls, bead fillers, and any other tire component that contains an elastomer. In one embodiment, the elastomeric composition is formed into tire tread, tire sidewalls, and/or bead fillers.

In certain embodiments, the elastomeric composition is incorporated into non-tire applications. Non-tire applications include, for example, a blow-out preventer, fire hoses, weather stripping, belts, injection molded parts, footwear, pharmaceutical closures, plant lining, flooring, power cables, gaskets, seals, and architectural trims. In particular, the elastomeric compositions can be utilized in various oil field applications such as, for example, blowout preventers, pump pistons, well head seals, valve seals, drilling hoses, pump stators, drill pipe protectors, down-hole packers, inflatable packers, drill motors, O-Rings, cable jackets, pressure accumulators, swab cups, and bonded seals.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

In this example, elastomeric compositions were produced using the masterbatch process. A number of different cellulose ester concentrates were prepared and subsequently combined with elastomers to produce the elastomeric compositions.

In the first stage of the masterbatch process, cellulose esters were bag blended with styrenic block copolymer materials and then fed using a simple volumetric feeder into the chilled feed throat of a Leitstritz twin screw extruder to make cellulose ester concentrates (i.e., masterbatches). The various properties of the cellulose esters and styrenic block copolymer materials utilized in this first stage are depicted in TABLES 1 and 2. All of the recited cellulose esters in TABLE 1 are from Eastman Chemical Company, Kingsport, Tenn. All of the styrenic block copolymers in TABLE 2 are from Kraton Polymers, Houston, Tex. The Leistritz extruder is an 18 mm diameter counter-rotating extruder having an L/D of 38:1. Material was typically extruded at 300 to 350 RPM with a volumetric feed rate that maintained a screw torque value greater than 50 weight percent. Samples were extruded through a strand die, and quenched in a water bath, prior to being pelletized. Relative loading levels of cellulose esters and styrenic block copolymers were varied to determine affect on mixing efficiency.

In the second stage, these cellulose ester concentrates were mixed with a base rubber formulation using a Brabender batch mixer equipped with roller type high shear blades. The base rubber was a blend of a styrene butadiene rubber (Buna 5025-2, 89.4 pph) and polybutadiene rubber (Buna CB24, 35 pph). Mixing was performed at a set temperature of 160° C. and a starting rotor speed of 50 RPM. RPM was decreased as needed to minimize overheating due to excessive shear. The cellulose ester concentrate loading level was adjusted so that there was about 20 weight percent cellulose ester in the final mix.

For the Comparative Examples, cellulose ester and plasticizer (i.e., no rubber) were first combined together in a Brabender batch mixer equipped with roller high shear blades in order to form a masterbatch. Plasticizer was added to enhance flow and lower viscosity as it has been observed that high viscosity cellulose esters will not mix at the processing temperature of the rubber (i.e., 150 to 160° C.). Mixing was performed for approximately 10 to 15 minutes at 160° C. and 50 RPM. Upon completion, the sample was removed and cryo-ground to form a powder.

In the next stage, 20 weight percent of the cellulose ester/plasticizer masterbatch was added to the rubber formulation using the same Brabender mixer at 160° C. and 50 RPM. The masterbatch was added 30 seconds after the rubber compound had been fully introduced into the mixer. Mixing was performed for approximately 10 minutes after all ingredients had been added. The sample was then removed and tested.

The particle sizes in the dispersion were measured using a compound light microscope (typically 40×). The samples could be cryo-polished to improve image quality and the microscope could run in differential interference contrast mode to enhance contrast.

The glass transition temperatures were measured using a DSC with a scanning rate of 20° C./minute.

The base formulations for all samples tested and produced as described below are depicted in TABLES 3A, 3B, and 3C.

TABLE 1

| | | Falling | | Melting |
|---|---|---|---|---|
| | | Ball | Tg | Range |
| Grade | Type | Viscosity | (° C.) | (° C.) |
| CAB | Cellulose acetate butyrate | 0.1 | 123 | 155-165 |
| 381-0.1 | | | | |
| CAB | Cellulose acetate butyrate | 0.5 | 130 | 155-165 |
| 381-0.5 | | | | |
| CAB 381-2 | Cellulose acetate butyrate | 2 | 133 | 171-184 |
| CAB 381-6 | Cellulose acetate butyrate | 6 | 135 | 184 to 190 |
| | | | (est) | (est) |
| CAB 381-20 | Cellulose acetate butyrate | 6 | 141 | 195-204 |
| CAP 482-0.5 | Cellulose acetate propionate | 0.5 | 142 | 188-210 |
| CAP 482-2 | Cellulose acetate propionate | 2 | 143 | 188-210 |
| CAP 482-6 | Cellulose acetate propionate | 6 | 144 | 188-210 |
| | | | (est) | (est) |
| CAP 482-20 | Cellulose acetate propionate | 6 | 147 | 188-210 |
| CA 398-30 | Cellulose acetate | 30 | 180 | 230-250 |

TABLE 2

| | | | MI @ | Diblock | Shore | MA |
|---|---|---|---|---|---|---|
| Grade | Type | Styrene | 200° C. | content | Hardness | bound |
| D1118KT | Diblock styrene/ | 33 wt % | 10 | 78 | 74 | Na |
| | butadiene | | | | | |
| D1102KT | Triblock styrene/ | 28 wt % | 14 | 17 | 66 | Na |
| | butadiene | | | | | |
| D1101KT | Triblock styrene/ | 31 wt % | <1 | 16 wt % | 69 | Na |
| | butadiene | | | | | |
| FG1924GT | Triblock, | 13 wt % | 40 @ | na | 49 | 0.7 to 1.3 wt % |
| | styrene ethylene/ | | 230° C. | | | |
| | butylene | | | | | |
| FG1901G | Triblock, | 30 wt % | 22 @ | na | 71 | 1.4 to 2.0 wt % |
| | styrene ethylene/ | | 230° C. | | | |
| | butylene | | | | | |

### Example 1(a)

In this example, a cellulose ester concentrate was produced that contained 40 weight percent of Eastman CAB 381-0.1 and 60 weight percent of Kraton FG1924. The materials were compounded using a medium shear screw design at max zone temperatures of 200° C. and a residence time of less than one minute. The cellulose ester concentrate was combined with the base rubber formulation at a 50:50 weight ratio and mixed in a Brabender mixer. The final elastomeric composition contained 50 weight percent of base rubber, 30 weight percent of Kraton FG 1924, and 20 weight percent of CAB 381-0.1. The particles were evenly dispersed and had particle sizes of less than 1 micron.

### Example 1(b)

In this example, a cellulose ester concentrate was produced that contained 60 weight percent of Eastman CAB 381-0.1 and 40 weight percent of Kraton FG1924. The materials were compounded using a medium shear screw design at max zone temperatures of 200° C. and a residence time less of than one minute. The cellulose ester concentrate was combined with the base rubber formulation at a 33.3/66.7 weight ratio and mixed in a Brabender mixer. The final formulation contained 66.7 weight percent of the base rubber, 13.3 weight percent of Kraton FG 1924, and 20 weight percent of CAB 381-0.1. The particles were evenly dispersed and had particle sizes of less than 3 microns, with most particles being less than 1 micron.

### Example 1(c)

In this example, a cellulose ester concentrate was produced that contained 40 weight percent of Eastman CAB 381-0.5 and 60 weight percent of Kraton FG1924. The materials were compounded using a medium shear screw design at max zone temperatures of 225° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1924, and 20 weight percent of CAB 381-0.5. The particles were evenly dispersed and had a particle size less than 1 micron.

### Example 1(d)

In this example, a cellulose ester concentrate was produced that contained 40 weight percent of Eastman CAB 381-2 and 60 weight percent of Kraton FG1924. The materials were compounded using a medium shear screw design at max zone temperatures of 250° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1924, and 20 weight percent of CAB 381-2. The particles were evenly dispersed and had particle sizes of less than 1 micron.

### Example 1(e)

In this example, a cellulose ester concentrate was produced that contained 40 weight percent of Eastman CAB 381-0.1 and 60 weight percent of Kraton D1102. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton D1102, and 20 weight percent of CAB 381-0.1. The particles were evenly dispersed and had particle sizes of less than 3 microns.

### Example 1(f)

In this example, a cellulose ester concentrate was produced that contained 40 weight percent of Eastman CAB 381-0.1 and 60 weight percent of Kraton D1101. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton D1101, and 20 weight percent of CAB 381-0.1. The particles were evenly dispersed and had particle sizes of less than 5 microns.

### Example 1(g)

In this example, a cellulose ester concentrate was produced that contained 40 weight percent of Eastman CAB 381-0.1 and 60 weight percent of Kraton D1118. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton D1118, and 20 weight percent of CAB 381-0.1. The particles were evenly dispersed and had particle sizes less than 3 microns.

### Example 1(h)

In this example, a cellulose ester concentrate was produced that contained 40 weight percent of Eastman CAP 482-0.5 and 60 weight percent of Kraton FG 1924. The materials were compounded using a medium shear screw design at max zone temperatures of 250° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1924, and 20 weight percent of CAP 482-0.5. The particles were evenly dispersed and had particle sizes of less than 1 micron.

### Example 1(i)

In this example, a cellulose ester concentrate was produced that contained 40 weight percent of Eastman CA 398-3 and 60 weight percent of Kraton FG 1924. The materials were compounded using a medium shear screw design at max zone temperatures of 250° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1924, and 20 weight percent of CA 398-3. The particles were evenly dispersed and had particle sizes less than 3 microns. Note that these particles will not soften or melt at 160° C. so any subsequent mixing with a primary elastomer would involve the dispersion of solid cellulosic particles.

### Example 1(j)

In this example, a cellulose ester concentrate was produced that contained 40 weight of percent Eastman CAB 381-0.1 and 60 weight percent of Kraton FG1901. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1901, and 20 weight percent of CAB 381-0.1. The particles were evenly dispersed and had particle sizes of less than 1 micron.

### Example 1(k)

In this example, a cellulose ester concentrate was produced that contained 40 weight percent of Eastman CAB 381-0.5 and 60 weight percent of Kraton FG1901. The materials were compounded using a medium shear screw design at max zone temperatures of 225° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent Kraton FG 1901, and 20 weight percent of CAB 381-0.5. The particles were evenly dispersed and had particle sizes of less than 1 micron.

### Example 1(l)

In this example, a cellulose ester concentrate was produced that contained 40 weight percent of Eastman CAB 381-2 and 60 weight percent of Kraton FG1901. The materials were compounded using a medium shear screw design at max zone temperatures of 250° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1901, and 20 weight percent of CAB 381-2. The particles were evenly dispersed and had particle sizes of less than 1 micron.

### Example 1(m)

In this example, a cellulose ester concentrate was produced that contained 40 weight percent of Eastman CAP 482-0.5 and 60 weight percent of Kraton FG1901. The materials were compounded using a medium shear screw design at max zone temperatures of 250° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1901, and 20 weight percent of CAP 482-0.5. The particles were evenly dispersed and had particle sizes of less than 3 microns.

### Example 1(n)

In this example, a cellulose ester concentrate was produced that contained 40 weight percent of Eastman CA 398-3 and 60 weight percent of Kraton FG 1901. The materials were compounded using a medium shear screw design at max zone temperatures of 250° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1901, and 20 weight percent of CA 398-3. The particles were evenly dispersed and had particle sizes of less than 1 micron. Note that these particles will not soften or melt at 160° C. so any subsequent mixing with a primary elastomer would involve the dispersion of solid cellulosic particles.

### Example 1(o)

In this example, 67 weight percent of Eastman CAB 381-20 was melt blended with 33 weight percent of Eastman CAB 381-0.5 to produce an estimated CAB 381-6 material having a falling ball viscosity of 6. Subsequently, 40 weight percent of this cellulose ester blend was melt blended with 60 weight percent of Kraton FG 1924. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1924, and 20 weight percent of CAB 381-6. The particles were evenly dispersed and had particle sizes of less than 3 microns.

### Example 1(p)

In this example, 67 weight percent of Eastman CAP 482-20 was melt blended with 33 weight percent of Eastman CAP 482-0.5 to produce an estimated CAP 482-6 material. Subsequently, 40 weight percent of this cellulose ester blend was melt blended with 60 weight percent of Kraton FG 1924. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton FG 1924, and 20 weight percent of CAP 482-6. The particles were evenly dispersed and had particle sizes of less than 1 micron. Note that this material will exhibit minimal flow at 160° C. so any subsequent mixing with a primary elastomer will involve the dispersion of essentially solid or “near-solid” particles.

### Example 1(q)

In this example, 67 weight percent of Eastman CAP 482-20 was melt blended with 33 weight percent of Eastman CAP 482-0.5 to produce an estimated CAP 482-6 material. Subsequently, 40 weight percent of this cellulose ester blend was melt blended with 60 weight percent of Kraton D1102. The materials were compounded using a medium shear screw design at max zone temperatures of 200° C. and a residence time of less than one minute. The cellulose ester concentrate was combined with the base rubber formulation at a 50/50 weight ratio and mixed in a Brabender mixer. The final formulation contained 50 weight percent of base rubber, 30 weight percent of Kraton D1102, and 20 weight percent of CAP 482-6. The particles were evenly dispersed and had particle sizes of less than 5 microns. Note that this material will exhibit minimal flow at 160° C. so any subsequent mixing with a primary elastomer will involve the dispersion of essentially solid or “near-solid” particles.

### Example 1(r)

In this example, 90 weight percent of Eastman CA 398-3 was melt blended with 10 weight percent of triphenyl phosphate to produce a plasticized cellulose acetate pre-blend. Subsequently, 40 weight percent of this plasticized cellulose acetate was melt blended with 60 weight percent Kraton D1102. The materials were compounded using a medium shear screw design at max zone temperatures of 200° C. and a residence time of less than one minute. The cellulose ester concentrate was combined with the base rubber formulation at a 66.7/33.3 weight ratio and mixed in a Brabender mixer. The final formulation contained 33.3 weight percent of base rubber, 40 weight percent of Kraton D1102, 20 weight percent of CA 398-3, and 6.67 weight percent triphenyl phosphate. The particles were evenly dispersed and had particle sizes of less than 3 microns. Note that this material will exhibit minimal flow at 160° C. so any subsequent mixing with a primary elastomer will involve the dispersion of essentially solid or “near-solid” particles.

### Example 1(s)

In this example, 90 weight percent of Eastman CA 398-3 was melt blended with 10 weight percent of triphenyl phosphate to produce a plasticized cellulose acetate pre-blend. Subsequently, 40 weight percent of this plasticized cellulose acetate was melt blended with 60 weight percent of Kraton FG 1924. The materials were compounded using a medium shear screw design at max zone temperatures of 200° C. and a residence time of less than one minute. The cellulose ester concentrate was combined with the base rubber formulation at a 66.7/33.3 weight ratio and mixed in a Brabender mixer. The final formulation contained 33.3 weight percent of base rubber, 40 weight percent of Kraton FG 1924, 20 weight percent of CA 398-3, and 6.67 weight percent of triphenyl phosphate. The particles were evenly dispersed and had particle sizes of less than 1 micron. Note that this material will exhibit minimal flow at 160° C. so any subsequent mixing with a primary elastomer will involve the dispersion of essentially solid or “near-solid” particles.

### Comparative Example 1(a)

In this example, a masterbatch was produced having 90 weight percent of Eastman CAB 381-0.1 and 10 weight percent of dioctyl adipate plasticizer. The CAB had a falling ball viscosity of 0.1 and the mixture had an estimated Tg of 95° C. The masterbatch was combined with the base rubber formulation at a 20/80 weight ratio and mixed in a Brabender mixer. This was done to simulate “direct mixing” as is currently practiced in the art. Most of the particles were evenly dispersed and had sizes predominantly between 5 and 10 microns; however, a few particles showed clustering in the 25 microns range.

### Comparative Example 1(b)

Following the same procedure as in Comparative Example 1(a), an attempt was made to mix Eastman CA 398-3 powder without plasticizer into the rubber formulation. The CA had a falling ball viscosity of 3 and a Tg of approximately 180° C. Mixing could not be performed because the CA would not soften at the mixing temperature of 160° C.

### Comparative Example 1(c)

Following the same procedure as in Comparative Example 1(a), a masterbatch was produced from a 50/50 mix of Eastman CA 398-3 and polyethylene glycol plasticizer. The high level of plasticizer was required in order to make the CA processable at 160° C. The Tg of the mixture was estimated to be less than 100° C. Particles partially dispersed but overall quality was poor with large clumps of cellulose acetate being present having particle sizes greater than 25 microns.

### Comparative Example 1(d)

Following the same procedure as in Comparative Example 1(a), a masterbatch was produced from a 75/25 mix of Eastman CAP 482-0.5 and dioctyl adipate plasticizer. The high level of plasticizer was required in order to make the CAP processable at 160° C. The Tg of the mixture was estimated to be less than 100° C. Particles partially dispersed but overall quality was poor with large clumps of cellulose acetate propionate being present having particle sizes greater than 25 microns.

### Comparative Example 1(e)

Following the same procedure as in Comparative Example 1(a), a masterbatch was produced from a 80/20 mix of Eastman CAP 482-0.5 and polyethylene glycol plasticizer. The high level of plasticizer was required in order to make the CAP processable at 160° C. The Tg of the mixture was estimated to be less than 100° C. Particles dispersed fairly well with most particles having sizes predominantly between 5 and 15 microns.

TABLE 3A

| | | | | | | | | | | |
|---|---|---|---|---|---|---|---|---|---|---|
| Example | Example | Example | Example | Example | Example | Example | Example | Example | Example | Example |
| 1(a) | 1(b) | 1(c) | 1(d) | 1(e) | 1(f) | 1(g) | 1(h) | 1(i) | 1(j) | 1(k) |

Cellulose Ester Concentrate Formulations

| | | | | | | | | | | | |
|---|---|---|---|---|---|---|---|---|---|---|---|
| Cellulose Ester | 40 | 60 | 40 | 40 | 40 | 40 | 40 | 40 | 40 | 40 | 40 |
| Carrier Elastomer | 60 | 40 | 60 | 60 | 60 | 60 | 60 | 60 | 60 | 60 | 60 |
| Plasticizer | — | — | — | — | — | — | — | — | — | — | — |
| CE Concentrate | 100 | 100 | 100 | 100 | 100 | 100 | 100 | 100 | 100 | 100 | 100 |
| (Total wt %) | | | | | | | | | | | |

Mixing Ratios for Elastomeric Compositions

| | | | | | | | | | | | |
|---|---|---|---|---|---|---|---|---|---|---|---|
| Base Rubber | 50 | 66.7 | 50 | 50 | 50 | 50 | 50 | 50 | 50 | 50 | 50 |
| CE Concentrate | 50 | 33.3 | 50 | 50 | 50 | 50 | 50 | 50 | 50 | 50 | 50 |
| Elastomeric | 100 | 100 | 100 | 100 | 100 | 100 | 100 | 100 | 100 | 100 | 100 |
| Composition | | | | | | | | | | | |
| (Total wt %) | | | | | | | | | | | |

Final Formulations of Produced Elastomeric Compositions

| | | | | | | | | | | | |
|---|---|---|---|---|---|---|---|---|---|---|---|
| Cellulose Ester | 20 | 20 | 20 | 20 | 20 | 20 | 20 | 20 | 20 | 20 | 20 |
| Carrier Elastomer | 30 | 13.3 | 30 | 30 | 30 | 30 | 30 | 30 | 30 | 30 | 30 |
| Base Rubber | 50 | 66.7 | 50 | 50 | 50 | 50 | 50 | 50 | 50 | 50 | 50 |
| Dispersion | <1 μm | <1 μm | <1 μm | <1 μm | <3 μm | <5 μm | <3 μm | <1 μm | <3 μm | <1 μm | <1 μm |
| Particle Size | | | | | | | | | | | |

TABLE 3B

| | | | | | | | | | |
|---|---|---|---|---|---|---|---|---|---|
| | | | | | | | | Comparative | Comparative |
| Example | Example | Example | Example | Example | Example | Example | Example | Example | Example |
| 1(l) | 1(m) | 1(n) | 1(o) | 1(p) | 1(q) | 1(r) | 1(s) | 1(a) | 1(b) |

Cellulose Ester Concentrate Formulations

| | | | | | | | | | | |
|---|---|---|---|---|---|---|---|---|---|---|
| Cellulose | 40 | 40 | 40 | 40 | 40 | 40 | 36 | 36 | 90 | — |
| Ester | | | | | | | | | | |
| Carrier | 60 | 60 | 60 | 60 | 60 | 60 | 60 | 60 | — | — |
| Elastomer | | | | | | | | | | |
| Plasticizer | — | — | — | — | — | — | 4 | 4 | 10 | — |
| CE | 100 | 100 | 100 | 100 | 100 | 100 | 100 | 100 | 100 | — |
| Concentrate | | | | | | | | | | |
| (Total wt %) | | | | | | | | | | |

Mixing Ratios for Elastomeric Compositions

| | | | | | | | | | | |
|---|---|---|---|---|---|---|---|---|---|---|
| Base Rubber | 50 | 50 | 50 | 50 | 50 | 50 | 33.3 | 33.3 | 80 | — |
| CE | 50 | 50 | 50 | 50 | 50 | 50 | 66.7 | 66.7 | 20 | — |
| Concentrate | | | | | | | | | | |
| Elastomeric | 100 | 100 | 100 | 100 | 100 | 100 | 100 | 100 | 100 | — |
| Composition | | | | | | | | | | |
| (Total wt %) | | | | | | | | | | |

Final Formulations of Produced Elastomeric Compositions

| | | | | | | | | | | |
|---|---|---|---|---|---|---|---|---|---|---|
| Cellulose | 20 | 20 | 20 | 20 | 20 | 20 | 20 | 20 | 18 | — |
| Ester | | | | | | | | | | |
| Carrier | 30 | 30 | 30 | 30 | 30 | 30 | 40 | 40 | — | — |
| Elastomer | | | | | | | | | | |
| Base Rubber | 50 | 50 | 50 | 50 | 50 | 50 | 33.3 | 33.3 | 80 | — |
| Plasticizer | — | — | — | — | — | — | 6.67 | 6.67 | 2 | — |
| Dispersion | <1 μm | <3 μm | <1 μm | <3 μm | <1 μm | <5 μm | <3 μm | <1 μm | 5-10 μm | — |
| Particle Size | | | | | | | | | | |

TABLE 3C

| | | |
|---|---|---|
| Comparative | Comparative | Comparative |
| Example 1(c) | Example 1(d) | Example 1(e) |

Cellulose Ester Concentrate Formulations

| | | | |
|---|---|---|---|
| Cellulose | 50 | 75 | 80 |
| Ester | | | |
| Carrier | — | — | — |
| Elastomer | | | |
| Plasticizer | 50 | 25 | 20 |
| CE | 100 | 100 | 100 |
| Concentrate | | | |
| (Total wt %) | | | |

Mixing Ratios for Elastomeric Compositions

| | | | |
|---|---|---|---|
| Base | 80 | 80 | 80 |
| Rubber | | | |
| CE | 20 | 20 | 20 |
| Concentrate | | | |
| Elastomeric | 100 | 100 | 100 |
| Composition | | | |
| (Total wt %) | | | |

Final Formulations of Produced Elastomeric Compositions

| | | | |
|---|---|---|---|
| Cellulose | 10 | 15 | 16 |
| Ester | | | |
| Carrier | — | — | — |
| Elastomer | | | |
| Base | 80 | 80 | 80 |
| Rubber | | | |
| Plasticizer | 10 | 5 | 4 |
| Dispersion | >25 μm | >25 μm | 10-15 μm |
| Particle Size | | | |

### Comparative Examples 2A and Examples 2A and 2B

TABLE 4A
Composition

| Example # | | |
|---|---|---|
| CE-2(a) | 2(a) | 2(b) |

Stage 1 mix conditions

| | | | | |
|---|---|---|---|---|
| Buna VSL 5025-2 | S-SBR¹, 37.5 phr | 89.38 | 89.38 | 89.38 |
| | TDAE², high vinyl | | | |
| | (67% of BD), 25% S | | | |
| CB24 | PBD³ rubber | 35 | 35 | 35 |
| Ultrasil ® 7000 | Silica | 65 | 65 | 65 |
| GR⁴ | | | | |
| N234 | Carbon Black | 15 | 15 | 15 |
| Si 266 | Coupling agent | 5.08 | 5.08 | 5.08 |
| Stearic acid | Cure Activator | 1.5 | 1.5 | 1.5 |

Stage 2 mix conditions (settings)

| Masterbatch | MB1 | 210.96 | 210.96 | 210.96 |
|---|---|---|---|---|
| Kraton ® D1118 | | | | |
| Kraton ® FG 1924 | | | | |
| TSMB1: Kraton ® FG1924 + 40 wt % | | | 37.5 | |
| CAB 381-0.1 | | | | |
| TSMB2: Kraton ® D1118 + 40 wt % CAB | | | | 37.5 |
| 381-0.1 | | | | |
| Zinc oxide | Cure activator | 1.9 | 1.9 | 1.9 |
| Okerin ® wax | microcrystalline | 1.5 | 1.5 | 1.5 |
| 7240⁵ | wax | | | |
| Santoflex ® | 6PPD | 2 | 2 | 2 |
| 6PPD⁶ | | | | |

Stage 3 (productive) mix condtions
(settings)

| | | | | |
|---|---|---|---|---|
| Masterbatch | MB2 | 210.96 | 253.86 | 253.86 |
| Sulfur | Cross-linker | 1.28 | 1.28 | 1.28 |
| Santocure ® CBS⁷ | Accelerator | 1.1 | 1.1 | 1.1 |
| Perkacit ® DPG- | Accelerator | 1.28 | 1.28 | 1.28 |
| grs⁸ | | | | |
| Total | | 214.62 | 257.52 | 257.52 |

¹S-SBR—solution styrene butadiene rubber obtained from Lanxess.
²TDAE—treated distillate aromatic extract
³PBD—polybutadiene rubber obtained from Lanxess
⁴Ultrasil 7000 GR silica obtained from Evonik Industries
⁵Okerin wax 7240 is a microcrystalline wax obtained from Sovereign Chemical
⁶Santoflex 6PPD is an anti-oxidant obtained from Flexsys.
⁷Santocure CBS is an accelerator obtained from Flexsys.
⁸Perkacit DPG-grs is an accelerator obtained from Flexsys.

TABLE 4B
Process Conditions
Banbury Mixing: The mixer was a Farrel BR mixer with steam
heating and water cooling which is instrumented with computer
monitors for temperature, rpm, and power.
Stage 1 mix conditions

| | |
|---|---|
| Start temperature | 65° C. |
| Starting rotor speed, | 65 |
| rpm | |
| Fill factor | 70% |
| Ram pressure | 50 |
| Mix sequence | at 0 min add elastomers |
| | at 1 min add ⅔ silica + Si266 |
| | at 2 min add ⅓ silica + others |
| | at 3 min sweep |
| | at 3.5 min adjust (increase) rotor speed |
| | to increase temperature to 160° C. at 4.5 min |
| Dump conditions | hold 2 min at 160° C. (total mix time = 6.5 min) |
| mill conditions | room temperature mill with knife flips for |
| | 2 min |

Stage 2 mix conditions

| | |
|---|---|
| start temperature | 65° C. |
| starting rotor speed, | 65 |
| rpm | |
| fill factor | 67% |
| ram pressure | 50 |
| mix sequence | at 0 min add ½ of first pass batch |
| | At 15 s add other ingredients (e.g. |
| | cellulosic masterbatch) and ½ of first |
| | pass batch |
| | at 1 min sweep. |
| | at 1.5 min adjust (increase) rotor speed, |
| | ramp temperature to 150° C. at 3.5 min |
| dump conditions | hold 4 min at 150° C. (Total mix time = 7.5 min) |
| mill conditions | room temperature mill with knife flips for |
| | 2 min |

Stage 3 mix conditions

| | |
|---|---|
| start temperature | 50° C. |
| starting rotor speed, | 60 |
| rpm | |
| fill factor | 64% |
| ram pressure | 50 |
| addition order | at 0 min add ½ 2nd pass batch, at 15 s |
| | add sulfur, accelerator package, & ½ |
| | 2nd pass batch, |
| | sweep at 1 min. |
| dump conditions | 110° C. or 2 min 30 s |
| mill conditions | room temperature mill with knife flips for |
| | 2 min |

TABLE 4C
Performance

| | | | | | DMA | |
|---|---|---|---|---|---|---|
| | | Mooney | | DMA (5% | (5% | |
| | | Viscosity | | stain in | stain in | Molded |
| | | at | | shear) | shear) | Groove |
| | | 100° C. | Phillips | Storage | Tan | Tear |
| Sample | | (Mooney | Disp. | Modulus at | Delta at | at 100° C. |
| Name | Additive | Units) | Rating | 30° C. (Pa) | 30° C. | lbf/in |
| Control, | None | 86.8 | 6 | 1.84E+06 | 0.238 | 134 |
| CE-2(a) | | | | | | |
| 2(a) | TSMB2A: Kraton ® 1924 + | 73.7 | 6 | 1.94E+06 | 0.215 | 103 |
| | 40 wt % CAB 381-0.1 | | | | | |
| 2(b) | TSMB2B: Kraton ® | 70.1 | 6 | 2.00E+06 | 0.229 | 135 |
| | D1118 + 40 wt % CAB | | | | | |
| | 381-0.1 | | | | | |

### Comparative Examples 2(a) and Examples 2(a) and 2(b)

For comparative example (CE-2(a)) and examples 2(a) and 2(b), the final mix was completed on a 1.5 L laboratory Farrel BR mixer that had steam heating and water cooling. Formulations are defined in Table 4A and mixing conditions in Table 4B. Final material properties are shown in Table 4C. Silica was typically added and dispersed in the 1^{st} stage mixing. For examples, 2(a) and 2(b), the twin screw masterbatch blends (TSMB2A and TSMB2B) were premade on a twin screw extruder and were added during the 2^{nd} stage of mixing. For examples 2(a) and 2(b), those masterbatch materials were added at 37.5 parts to target a cellulose ester loading of 15 parts while also adding 22.5 parts of Kraton® rubber.

### Comparative Example 2(a)

The final rubber was observed to have a Mooney viscosity of 80 units while the storage modulus at 30° C. was less than 1.80 E+06 Pa. The measured tan delta was 0.238 and molded groove tear of 134 lbf/in.

### Example 2(a)

The carrier elastomer in Example 2(a) was Kraton® FG 1924 rubber and the cellulose ester was CAB 381-0.1. Compared to Comparative Example 2(a), the Mooney viscosity was reduced, the dispersion was the same, and the storage modulus at 30° C. increased. Similarly, the measured tan delta was decreased relative to the comparative example, while the molded groove tear decreased slightly.

### Example 2(b)

The carrier elastomer in example 2(b) was Kraton® D1118 rubber, and the cellulose ester was CAB 381-0.1. The twin screw masterbatch (TSMB2B) was added in the 2^{nd} stage of the Banbury mixing. The material properties can be seen in Table 4C, and the data show that the Mooney Viscosity had been reduced compared to the control, the dispersion was similar, and the storage modulus at 30° C. increased. The measured tan delta decreased relative to the comparative example, while the molded groove tear was slightly higher.

### Comparative Examples 3(a) and 3(b) and Examples 3(a) through 3(l)

TABLE 5A-1

| | | Example # | | | | |
|---|---|---|---|---|---|---|
| | | CE-3(a) | CE-3(b) | 3(a) | 3(b) | 3(c) |
| Buna VSL 5025-2 | S-SBR¹, | 89.38 | 58.43 | 58.43 | 58.43 | 75.63 |
| | 37.5phr TDAE², | | | | | |
| | high vinyl (67% | | | | | |
| | of BD), 25% S | | | | | |
| CB24 | PBD³ rubber | 35 | 35 | 35 | 35 | 35 |
| Ultrasil ® 7000 | Silica | 80 | 65 | 65 | 65 | 65 |
| GR⁴ | | | | | | |
| N234 | Carbon Black | 15 | 15 | 15 | 15 | 15 |
| Si 266 | Coupling agent | 6.24 | 5.07 | 5.07 | 5.07 | 5.07 |
| Tudalen 4192⁵ | Process | 0 | 8.45 | 8.45 | 8.45 | 3.75 |
| | Additive | | | | | |
| Stearic acid | Cure Activator | 1.5 | 1.5 | 1.5 | 1.5 | 1.5 |

Stage 2 mix conditions (settings)

| masterbatch | MB1 | 227.12 | 188.45 | 188.45 | 188.45 | 200.95 |
|---|---|---|---|---|---|---|
| TSMB3A: Blend of 40 wt % CAB 381- | | | | 37.5 | | |
| 0.1 and 60 wt % Kraton ® FG 1924 | | | | | | |
| TSMB3B: Blend of 40 wt % CAB 381- | | | | | 37.5 | |
| 0.1 and 60 wt % Kraton ® D1118 | | | | | | |
| TSMB3C: Blend of 60 wt % CAB 381- | | | | | | 25 |
| 0.1 and 40 wt % Kraton ® FG 1924 | | | | | | |
| Si 266 | Coupling Agent | | | 1.17 | 1.17 | 1.17 |
| Zinc oxide | Cure activator | 1.9 | 1.9 | 1.9 | 1.9 | 1.9 |
| Okerin ® wax | microcrystalline | 1.5 | 1.5 | 1.5 | 1.5 | 1.5 |
| 7240⁶ | wax | | | | | |
| Santoflex ® 6PPD⁷ | 6PPD | 2 | 2 | 2 | 2 | 2 |

Stage 3 (productive) mix condtions (settings)

| | | | | | | |
|---|---|---|---|---|---|---|
| Masterbatch | MB2 | 232.52 | 193.85 | 232.35 | 232.35 | 232.35 |
| Sulfur | Cross-linker | 1.28 | 1.28 | 1.28 | 1.28 | 1.28 |
| Santocure ® CBS⁸ | Accelerator | 1.1 | 1.1 | 1.1 | 1.1 | 1.1 |
| Perkacit ® DPG- | Accelerator | 1.28 | 1.28 | 1.28 | 1.28 | 1.28 |
| grs⁹ | | | | | | |

| | | | | | |
|---|---|---|---|---|---|
| Total | 236.18 | 197.51 | 236.18 | 236.18 | 236.18 |

¹S-SBR—solution styrene butadiene rubber obtained from Lanxess.
²TDAE—treated distillate aromatic extract
³PBD—polybutadiene rubber obtained from Lanxess
⁴Ultrasil 7000 GR silica obtained from Evonik Industries
⁵Tudelen 4192—treated distillate aromatic extract obtained by the H&R Group
⁶Ultrasil 7000 GR silica obtained from Evonik Industries
⁷Okerin wax 7240 is a microcrystalline wax obtained from Sovereign Chemical
⁸Santoflex 6PPD is an anti-oxidant obtained from Flexsys.
⁹Santocure CBS is an accelerator obtained from Flexsys.
¹⁰Perkacit DPG-grs is an accelerator obtained from Flexsys.

TABLE 5A-2

| Example # | | | | |
|---|---|---|---|---|
| 3(d) | 3(e) | 3(f) | 3(g) | 3(h) |

Stage 1 mix conditions (settings)

| | | | | | | |
|---|---|---|---|---|---|---|
| Buna VSL 5025-2 | S-SBR¹, | 58.43 | 58.43 | 58.43 | 58.43 | 58.43 |
| | 37.5phr TDAE², | | | | | |
| | high vinyl (67% | | | | | |
| | of BD), 25% S | | | | | |
| CB24 | PBD³ rubber | 35 | 35 | 35 | 35 | 35 |
| Ultrasil ® 7000 GR⁴ | Silica | 65 | 65 | 65 | 65 | 65 |
| N234 | Carbon Black | 15 | 15 | 15 | 15 | 15 |
| Si 266 | Coupling agent | 5.07 | 5.07 | 5.07 | 5.07 | 5.07 |
| Tudalen 4192⁵ | Process | 8.45 | 8.45 | 8.45 | 8.45 | 8.45 |
| | Additive | | | | | |
| Stearic acid | Cure Activator | 1.5 | 1.5 | 1.5 | 1.5 | 1.5 |

Stage 2 mix conditions (settings)

| masterbatch | MB1 | 188.45 | 188.45 | 188.45 | 188.45 | 188.45 |
|---|---|---|---|---|---|---|
| TSMB3D: Blend of 40 wt % CAB 381- | | 37.5 | | | | |
| 0.1 and 60 wt % Kraton ® D1102 | | | | | | |
| TSMB3E: Blend of 40 wt % CAB 381- | | | 37.5 | | | |
| 0.1 and 60 wt % Kraton ® FG1901 | | | | | | |
| TSMB3F: Blend of 40 wt % CAB 381- | | | | 37.5 | | |
| 0.1 and 60 wt % JSR RB 820⁶ | | | | | | |
| TSMB3G: Blend of 40 wt % CAB 381-2 | | | | | 37.5 | |
| and 60 wt % Kraton ® FG1924 | | | | | | |
| TSMB3H: Blend of 40 wt % CAP 482- | | | | | | 37.5 |
| 0.5 and 60 wt % Kraton ® FG1924 | | | | | | |
| Si 266 | Coupling Agent | 1.17 | 1.17 | 1.17 | 1.17 | 1.17 |
| Zinc oxide | Cure activator | 1.9 | 1.9 | 1.9 | 1.9 | 1.9 |
| Okerin ® wax⁷ | microcrystalline | 1.5 | 1.5 | 1.5 | 1.5 | 1.5 |
| 7240⁸ | wax | | | | | |
| Santoflex ® 6PPD⁸ | 6PPD | 2 | 2 | 2 | 2 | 2 |

Stage 3 (productive) mix condtions (settings)

| | | | | | | |
|---|---|---|---|---|---|---|
| masterbatch | MB2 | 232.35 | 232.35 | 232.35 | 232.35 | 232.52 |
| Sulfur | Cross-linker | 1.28 | 1.28 | 1.28 | 1.28 | 1.28 |
| Santocure ® CBS⁹ | Accelerator | 1.1 | 1.1 | 1.1 | 1.1 | 1.1 |
| Perkacit ® DPG- | Accelerator | 1.28 | 1.28 | 1.28 | 1.28 | 1.28 |
| grs¹⁰ | | | | | | |

| | | | | | |
|---|---|---|---|---|---|
| Total | 236.18 | 236.18 | 236.18 | 236.18 | 236.18 |

¹S-SBR—solution styrene butadiene rubber obtained from Lanxess.
²TDAE—treated distillate aromatic extract
³PBD—polybutadiene rubber obtained from Lanxess
⁴Ultrasil 7000 GR silica obtained from Evonik Industries
⁵Tudelen 4192—treated distillate aromatic extract obtained by the H&R Group
⁶JSR RB 820—syndiotactic, 1,2 polybutadiene obtained from JSR Corporation
⁷Okerin wax 7240 is a microcrystalline wax obtained from Sovereign Chemical
⁸Santoflex 6PPD is an anti-oxidant obtained from Flexsys.
⁹Santocure CBS is an accelerator obtained from Flexsys.
¹⁰Perkacit DPG-grs is an accelerator obtained from Flexsys.

TABLE 5A-3

| | | Example # | | | |
|---|---|---|---|---|---|
| | | 3(i) | 3(j) | 3(k) | 3(l) |
| Buna VSL 5025-2 | S-SBR¹, 37.5 phr | 58.43 | 58.43 | 58.43 | 55 |
| | TDAE², high vinyl | | | | |
| | (67% of BD), 25% S | | | | |
| CB24 | PBD³ rubber | 35 | 35 | 35 | 35 |
| Ultrasil ® 7000 GR⁴ | Silica | 65 | 65 | 65 | 65 |
| N234 | Carbon Black | 15 | 15 | 15 | 15 |
| Si 266 | Coupling agent | 5.07 | 5.07 | 5.07 | 5.07 |
| Tudalen 4192⁵ | Process Additive | 8.45 | 8.45 | 8.45 | 9.38 |
| Stearic acid | Cure Activator | 1.5 | 1.5 | 1.5 | 1.5 |

Stage 2 mix conditions (settings)

| Masterbatch | MB1 | 188.45 | 188.45 | 188.45 | 185.95 |
|---|---|---|---|---|---|
| TSMB3I: Blend of 40 wt % CAP 482-0.5 and | | 37.5 | | | |
| 60 wt % Kraton ® FG1901 | | | | | |
| TSMB3J: Blend of 40 wt % CA 398-3 and | | | 37.5 | | |
| 60 wt % Kraton ® FG1924 | | | | | |
| TSMB3K: Blend of 40 wt % CA 398-3 and | | | | 37.5 | |
| 60 wt % Kraton ® FG1901 | | | | | |
| TSMB3L: Blend of 36 wt % CA 398-3 with | | | | | 41.6 |
| 4% triphenyl phosphate plasticizer and | | | | | |
| 60 wt % Kraton ® FG1924 | | | | | |
| Si 266 | Coupling Agent | 1.17 | 1.17 | 1.17 | 1.17 |
| Zinc oxide | Cure activator | 1.9 | 1.9 | 1.9 | 1.9 |
| Okerin ® wax 7240⁶ | microcrystalline wax | 1.5 | 1.5 | 1.5 | 1.5 |
| Santoflex ® 6PPD⁷ | 6PPD | 2 | 2 | 2 | 2 |

Stage 3 (productive) mix condtions
(settings)

| | | | | | |
|---|---|---|---|---|---|
| Masterbatch | MB2 | 232.35 | 232.52 | 232.35 | 234.12 |
| Sulfur | Cross-linker | 1.28 | 1.28 | 1.28 | 1.28 |
| Santocure ® CBS⁸ | Accelerator | 1.1 | 1.1 | 1.1 | 1.1 |
| Perkacit ® DPG-grs⁹ | Accelerator | 1.28 | 1.28 | 1.28 | 1.28 |
| Total | | 236.18 | 236.18 | 236.18 | 237.78 |

¹S-SBR—solution styrene butadiene rubber obtained from Lanxess.
²TDAE—treated distillate aromatic extract
³PBD—polybutadiene rubber obtained from Lanxess
⁴Ultrasil 7000 GR silica obtained from Evonik Industries
⁵Tudelen 4192 - treated distillate aromatic extract obtained by the H&R Group
⁶Okerin wax 7240 is a microcrystalline wax obtained from Sovereign Chemical
⁷Santoflex 6PPD is an anti-oxidant obtained from Flexsys.
⁸Santocure CBS is an accelerator obtained from Flexsys.
⁹Perkacit DPG-grs is an accelerator obtained from Flexsys.

TABLE 5B
Process Conditions
Banbury Mixing: The mixer is a Farrel BR mixer with steam
heating and water cooling which is instrumented with computer
monitors for temperature, rpm, and power.
Stage 1 mix conditions

| | |
|---|---|
| Start temperature | 65° C. |
| Starting rotor speed, | 65 |
| rpm | |
| Fill factor | 70% |
| Ram pressure | 50 |
| Mix sequence | at 0 min add elastomers |
| | at 1 min add ⅔ silica + Si266 |
| | at 2 min add ⅓ silica + others |
| | at 3 min sweep |
| | at 3.5 min adjust (increase) rotor speed |
| | to increase temperature to 160° C. at 4.5 min |
| Dump conditions | hold 2 min at 160° C. (total mix time = 6.5 min) |
| mill conditions | room temperature mill with knife flips for |
| | 2 min |

Stage 2 mix conditions

| | |
|---|---|
| start temperature | 65° C. |
| starting rotor speed, | 65 |
| rpm | |
| fill factor | 67% |
| ram pressure | 50 |
| mix sequence | at 0 min add ½ of first pass batch |
| | At 15 s add other ingredients (e.g. |
| | cellulosic masterbatch) and ½ of first |
| | pass batch |
| | at 1 min sweep. |
| | at 1.5 min adjust (increase) rotor speed, |
| | ramp temperature to 150° C. at 3.5 min |
| dump conditions | hold 4 min at 150° C. (Total mix time = 7.5 min) |
| mill conditions | room temperature mill with knife flips for |
| | 2 min |

Stage 3 mix conditions

| | |
|---|---|
| start temperature | 50° C. |
| starting rotor speed, | 60 |
| rpm | |
| fill factor | 64% |
| ram pressure | 50 |
| addition order | at 0 min add ½ 2nd pass batch, at 15 s |
| | add sulfur, accelerator package, & ½ |
| | 2nd pass batch, |
| | sweep at 1 min. |
| dump conditions | 110° C. or 2 min 30 s |
| mill conditions | room temperature mill with knife flips for |
| | 2 min |

TABLE 5C
Performance

| | | Mooney | | DMA (5% | | |
|---|---|---|---|---|---|---|
| | | Viscosity | | stain in | DMA (5% | Molded |
| | | at | | shear) | stain in | Groove |
| | | 100° C. | Phillips | Storage | shear) | Tear at |
| Sample | | (Mooney | Disp. | Modulus at | Tan Delta | 100° C. |
| Name | Additive | Units) | Rating | 30° C. (Pa) | at 30° C. | lbf/in |
| Control, | None | 97.3 | 7 | 2.12E+06 | 0.304 | 77.7 |
| CE-3(a) | | | | | | |
| Control | None | 81.4 | 5 | 2.10E+06 | 0.297 | 94 |
| CE-3(b) | | | | | | |
| 3(a) | TSMB3A: Blend of | 71.8 | 6 | 2.37E+06 | 0.275 | 106 |
| | 40 wt % CAB 381-0.1 and | | | | | |
| | 60 wt % Kraton ® FG 1924 | | | | | |
| 3(b) | TSMB3B: Blend of | 70.1 | 7 | 2.48E+06 | 0.304 | 136 |
| | 40 wt % CAB 381-0.1 and | | | | | |
| | 60 wt % Kraton ® D1118 | | | | | |
| 3(c) | TSMB3C: Blend of | 74.7 | 5 | 2.21E+06 | 0.279 | 120 |
| | 60 wt % CAB 381-0.1 and | | | | | |
| | 40% Kraton ® FG 1924 | | | | | |
| 3(d) | TSMB3D: Blend of | 64.6 | 8 | 2.38E+06 | 0.281 | 163 |
| | 40 wt % CAB 381-0.1 and | | | | | |
| | 60 wt % Kraton ® D1102 | | | | | |
| 3(e) | TSMB3E: Blend of | 78.7 | 7 | 2.86E+06 | 0.286 | 93 |
| | 40 wt % CAB 381-0.1 and | | | | | |
| | 60 wt % Kraton ® FG1901 | | | | | |
| 3(f) | TSMB3F: Blend of | 62.3 | 8 | 2.94E+06 | 0.290 | 111 |
| | 40 wt % CAB 381-0.1 and | | | | | |
| | 60 wt % JSR RB 820 | | | | | |
| 3(g) | TSMB3G: Blend of | 77.9 | 8 | 2.53E+06 | 0.278 | 83 |
| | 40 wt % CAB 381-2 and | | | | | |
| | 60 wt % Kraton ® FG1924 | | | | | |
| 3(h) | TSMB3H: Blend of | 84.3 | 9 | 2.63E+06 | 0.275 | 147 |
| | 40 wt % CAP 482-0.5 and | | | | | |
| | 60 wt % Kraton ® FG1924 | | | | | |
| 3(i) | TSMB3I: Blend of 40 wt % | 83.3 | 8 | 2.81E+06 | 0.298 | 118 |
| | CAP 482-0.5 and 60 wt % | | | | | |
| | Kraton ® FG1901 | | | | | |
| 3(j) | TSMB3J: Blend of | 81.7 | 7 | 2.21E+06 | 0.252 | 89 |
| | 40 wt % CA 398-3 and | | | | | |
| | 60 wt % Kraton ® FG1924 | | | | | |
| 3(k) | TSMB3K: Blend of | 84.5 | 9 | 2.79E+06 | 0.298 | 113 |
| | 40 wt % CA 398-3 and | | | | | |
| | 60 wt % Kraton ® FG1901 | | | | | |
| 3(l) | TSMB3L: Blend of | 80.4 | 9 | 2.35E+06 | 0.261 | 85 |
| | 36 wt % CA 398-3 with 4% | | | | | |
| | triphenyl phosphate | | | | | |
| | plasticizer and 60 wt % | | | | | |
| | Kraton ® FG1924 | | | | | |

### Comparative Examples 3(a) and 3(b) and Examples 3(a) through 3(l)

For comparative examples (CE-3(a) and CE-3(b)) and examples 3(a) through 3(l), the final mix was completed on a 1.5 L laboratory Farrel BR mixer that had steam heating and water cooling. The mixing conditions can be seen in Tables 5B, the formulations in Tables 5A-1, 5A-2, and 5A-3, and the property data in Table 5C. For examples 3(a) through 3(l), the twin screw masterbatch blends (TSMB3A through TSMB3L) were premade on a twin screw extruder prior to adding them to the final mix in the 2^{nd} stage. These masterbatch materials were added to target a cellulose ester loading of 15 parts.

### Comparative Example 3(a)

This control formulation is based on 80 parts silica which is compared to 65 silica and 15 parts cellulose ester in the examples. A Mooney viscosity of 97.3 units was observed while the storage modulus at 30° C. was 2.12 E+06 Pa. The measured tan delta was 0.304 and molded groove tear of 77.7. The Phillips dispersion was 7.

### Comparative Example 3(b)

This control formulation is based on 65 parts silica which is compared to 65 silica and 15 parts cellulose ester in the examples. A Mooney viscosity of 81.4 units was observed while the storage modulus at 30° C. was 2.10 E+06 Pa. The measured tan delta was 0.297 and molded groove tear of 94. The Phillips dispersion was 5.

### Example 3(a)

The carrier elastomer in example 3(a) was Kraton® FG 1924 and the cellulose ester was CAB 381-0.1. The estimated Tg of the cellulose ester was 123° C. The masterbatch was a blend of 40 weight percent cellulose ester with 60 weight percent Kraton® FG1924 rubber made on a 18 mm Leistritz twin screw extruder (melt compounded at 200° C. with a residence time of less than one minute). The twin screw masterbatch (TSMB3A) was subsequently added in the 2^{nd} stage of the Banbury mixing to target a cellulose ester loading of 15 parts. The material properties can be seen in Table 5C. Mooney viscosity has been reduced compared to the both comparative examples while the dispersion was similar, and the storage modulus at 30° C. increased. The measured tan delta decreased relative to the comparative examples while the molded groove tear increased.

### Example 3(b)

Example 3(b) is identical to 3(a) except the carrier elastomer is Kraton® D1118. Mooney viscosity has been reduced compared to the both comparative examples, while the dispersion was similar, and the storage modulus at 30° C. increased. The measured tan delta was similar to the controls in the comparative examples while the molded groove tear increased.

### Example 3(c)

Example 3(c) is identical to 3(a) except the twin screw masterbatch (TSMB3C) was a blend of 60 weight percent CAB 381-0.1 and 40 weight percent Kraton FG 1924. Mooney viscosity was reduced compared to both comparative examples, the dispersion was similar, and the storage modulus at 30° C. increased. The measured tan delta decreased relative to the comparative examples while the molded groove tear increased.

### Example 3(d)

Example 3(d) is identical to 3(a) except the carrier elastomer was Kraton® D1102. Mooney viscosity was reduced compared to both comparative examples, the dispersion and the storage modulus at 30° C. increased. The measured tan delta decreased relative to the comparative examples while the molded groove tear increased substantially.

### Example 3(e)

Example 3(e) is identical to 3(a) except the carrier elastomer was Kraton® FG1901. Mooney viscosity was reduced compared to both comparative examples, the dispersion was similar, and the storage modulus at 30° C. increased. The measured tan delta decreased relative to the comparative examples while the molded groove tear increased relative to CE-3(a) but was similar to CE-3(b).

### Example 3(f)

In this example, this formulation can be seen in Table 5A-2 and mixing conditions can be seen in Table 5B. The carrier elastomer in example 3F was JSR RB 820, and the cellulose ester was CAB 381-0.1. The masterbatch was a blend of 40 weight percent cellulose ester with 60 weight percent JSR RB 820 processed similar to Example 3(a). Mooney viscosity was reduced compared to both comparative examples, the dispersion was improved, while the storage modulus at 30° C. increased. The measured tan delta s decreased relative to the comparative examples while the molded groove tear increased.

### Example 3(g)

Example 3(g) is identical to 3(a) except the carrier elastomer was Kraton® FG1924 and the cellulose ester was CAB 381-2. The estimated Tg of the cellulose ester was 133° C., and the masterbatch was melt compounded at 250° C. Mooney viscosity was reduced compared to the comparative examples, the dispersion was improved, and the storage modulus at 30° C. increased. The measured tan delta was decreased relative to the comparative examples while the molded groove tear was better than CE-3(a) and slightly lower than CE-2(b).

### Example 3(h)

Example 3(h) is identical to 3(g) except the cellulose ester was CAP 482-0.5 (estimated Tg of 142° C.). Mooney viscosity was reduced compared to CE-3(a) but was similar to CE-3(b). The dispersion was improved while the storage modulus at 30° C. increased. The measured tan delta was decreased relative to the comparative examples while the molded groove tear was better than CE-3(a) and slightly lower than CE-2(b).

### Example 3(i)

The formulation for this example is detailed in Table 5A-3 and mixing conditions in Table 5B. The carrier elastomer was Kraton® FG 1901, and the cellulose ester was CAP 482-0.5. Mooney viscosity was reduced compared to CE-3(a) and was similar to CE-3(b). The dispersion improved while the storage modulus at 30° C. increased. The measured tan delta was decreased relative to CE-3(a) and was similar to CE 3(b) while the molded groove tear increased relative to both comparative examples.

### Example 3(j)

Example 3(j) is identical to 3(i) except the carrier elastomer was Kraton® FG 1924, and the cellulose ester was CA 398-3 (estimated Tg of 180° C.). Mooney viscosity was reduced compared to CE-3(a) but was similar to CE-3(b). The dispersion was similar while the storage modulus at 30° C. increased. The measured tan delta decreased relative to both comparative examples while the molded groove tear increased relative to CE-3(a) but was slightly lower than CE-3(b).

### Example 3(k)

Example 3(k) is identical to 3(j) except the carrier elastomer was Kraton® FG 1901, Mooney viscosity was reduced compared to CE-3(a) and was similar to CE-3(b). The dispersion increased while the storage modulus at 30° C. also increased. The measured tan delta decreased relative to CE-3(a) and was similar to CE-3(b) while the molded groove tear increased relative to both comparative examples.

### Example 3(l)

Example 3(l) was identical to 3(k) except the CA 398-3 was plasticized with 10 wt % triphenyl phosphate. The estimated Tg of the plasticized cellulose ester was lowered to 155° C. The masterbatch was a blend of 36 weight percent cellulose ester with 10% triphenyl phosphate and then blended with 60 weight percent Kraton FG1901. Mooney viscosity was reduced compared to CE-3(a) and CE-3(b). The dispersion increased while the storage modulus at 30° C. also increased. The measured tan delta decreased relative to CE-3(a) and CE-3(b) while the molded groove tear increased relative to CE-3(a) and decreased relative to CE-3(b).

That which is claimed is:

1. An elastomeric composition comprising at least one non-fibril cellulose ester, at least one carrier elastomer, and at least one primary elastomer, wherein said elastomeric composition exhibits a dynamic mechanical analysis (DMA) strain sweep modulus as measured at 5% strain and 30° C. of at least 1,450,000 Pa and a molded groove tear as measured according to ASTM D624 of at least 120 lbf/in.

2. The elastomeric composition according to claim 1 wherein said cellulose ester has a Tg of at least 90° C. and/or not more than 190° C.

3. The elastomeric composition according to claim 1 wherein said elastomeric composition exhibits a Mooney viscosity at 100° C. as measured according to ASTM D 1646 of not more than 110 AU when uncured.

4. The elastomeric composition according to claim 1 wherein said elastomeric composition exhibits a DMA strain sweep modulus as measured at 5% strain and 30° C. of at least 1,500,000 Pa.

5. The elastomeric composition according to claim 1 wherein said elastomeric composition exhibits a molded groove tear as measured according to ASTM D624 of at least 130 lbf/in.

6. The elastomeric composition according to claim 1 wherein said elastomeric composition comprises at least 1 and/or not more than 75 phr of said cellulose ester.

7. The elastomeric composition according to claim 1 wherein said cellulose ester exhibits a falling ball viscosity of at least 0.005 and/or not more than 50.

8. The elastomeric composition according to claim 1 wherein at least 75 percent of said particles have an aspect ratio of not more than 2:1.

9. The elastomeric composition according to claim 1 wherein at least 75 percent of said particles have a particle size of not more than 10 μm.

10. The elastomeric composition according to claim 1 wherein said cellulose ester is selected from the group consisting of cellulose acetate, cellulose acetate propionate, cellulose acetate butyrate cellulose triacetate, cellulose tripropionate, cellulose tributyrate, and mixtures thereof.

11. The elastomeric composition according to claim 1 wherein said cellulose ester is a modified cellulose ester, wherein said modified cellulose ester has been modified with a plasticizer.

12. The elastomeric composition according to claim 1 wherein said carrier elastomer is non-nitrile.

13. The elastomeric composition according to claim 1 wherein said carrier elastomer is selected from the group consisting of styrene block copolymers, polybutadienes, natural rubbers, synthetic rubbers, acrylics, maleic anhydride modified styrenics, recycled rubber, crumb rubber, powdered rubber, isoprene rubber, nitrile rubber, and combinations thereof.

14. The elastomeric composition according to claim 1 wherein said carrier elastomer is selected from the group consisting of styrene block copolymers, polybutadienes, natural rubbers, synthetic rubbers, acrylics, maleic anhydride modified styrenics, recycled rubber, crumb rubber, powdered rubber, isoprene rubber, and combinations thereof.

15. The elastomeric composition according to claim 1 wherein said primary elastomer is non-polar.

16. The elastomeric composition according to claim 1 wherein said primary elastomer comprises a non-nitrile elastomer.

17. The elastomeric composition according to claim 1 wherein said primary elastomer is selected from the group consisting of natural rubber, polybutadiene, polyisoprene, styrene-butadiene rubber, polyolefins, ethylene propylene diene monomer (EPDM), polynorbornene, and combinations thereof.

18. The elastomeric composition according to claim 1 wherein said elastomeric composition comprises at least 5 phr and/or not more than 150 phr of one more fillers.

19. An article comprising said elastomeric composition of claim 1.

20. The article according to claim 19 wherein said article is a tire.
